(19) United States
(12) Patent Application Publication
(10) Pub. No.: US 2024/0380759 A1
(43) Pub. Date: Nov. 14, 2024

(54) SYSTEMS AND METHODS FOR SECURELY PRESENTING CONTEXT-AWARE USER NOTIFICATIONS

(71) Applicant: Wells Fargo Bank, N.A., San Francisco, CA (US)

(72) Inventors: Matt T. Graves, Phoenix, AZ (US); Debashis Ghosh, Charlotte, NC (US)

(21) Appl. No.: 18/313,711

(22) Filed: May 8, 2023

(51) Int. Cl. H04L 9/40; G06F 9/54

(52) U.S. Cl. CPC H04L 63/107; G06F 9/542; H04L 63/102; H04L 63/108

(57) ABSTRACT

Systems, apparatuses, methods, and computer program products are disclosed for securely presenting a context-aware user notification to a user using a facility device. An example method includes receiving a user participation request for the user, wherein the user participation request comprises (i) a user characteristic attribute set and (ii) a user identification attribute set and determining a current user location based on the user characteristic attribute set and a temporal image set. The method further includes generating a display configuration set for a facility device indicative of instructions for the facility device for displaying the context-aware user notification based on the current user location. The method further includes generating the context-aware user notification based on the current user location and the user identification set and providing a display message to the facility device, wherein the display message comprises the context-aware user notification and the display configuration set.

### BACKGROUND

The presentation of certain information to users while they are within a facility may be advantageous to the users and may provide useful information that can be used to inform their decisions while within the facility. However, the method of presentation of information to the user carries an associated security risk in instances in which the information includes sensitive or private information of the user.

### BRIEF SUMMARY

As described above, the presentation of certain information to users while they are within a facility may be advantageous to the users and may provide useful information that can be used to inform their decisions while within the facility. For example, a user may wish to know a fund availability in his/her associated financial accounts such that he/she may make an informed decision regarding product purchases while in a facility, such as a merchant store. As another example, a user may have multiple credit card associated with different reward points and/or values and may wish to maximize their earned rewards but may not have such information at hand during his/her visit to the facility. It may therefore be advantageous automatically provide users with such information during their visit to the facility such that they may make informed decisions without having to leave the facility.

However, the presentation of this information may include sensitive or private user information such that it may be difficult to present such bespoke user information to the user in a secure manner. While generic information regarding the facility and its objects may be displayed to users, this information lacks specificity to the user and may therefore be irrelevant to the user. Furthermore, these static types of information displays lack the ability to be tailored to the user such that he/she may remain unaware of user-specific recommendations based his/her associated user parameters and data. For example, generic facility discounts may be displayed throughout the store but are generic in nature and furthermore, may rely on the user to determine if he/she qualifies for offers.

In contrast to these conventional static techniques for generation and presentation of facility-specific information, example embodiments described herein allow for the generation of bespoke context-aware user notification that may be securely presented to the user using a facility device. In particular, a user may choose to opt into a user notification program that allows facility devices to securely provide context-aware user notification to the user within a facility. To do so, the user may interact with a facility device, which may capture user characteristic attributes of the user and user identification attributes. A user analytics system may then track the user throughout the facility using the user identification attributes and for the duration of the user's time within the facility, the user may be presented with context-aware user notifications when they are within a particular proximity to a facility device such that the facility device may display the context-aware user notification to the user in a secure and private manner.

Additionally, techniques described herein may only utilize, store, or otherwise maintain the one or more user characteristic attributes in the user characteristic attribute set for the duration the user is within the facility. The user characteristic attributes may be deleted after the user location cannot be determined for a predetermined time. As opposed to conventional tracking systems which may use biometric data, the use of a user characteristic attribute set advantageously allows for any user to opt into the user notification program and does not require that the user be registered with a user profile associated with the facility. As such, biometric data of the user need not be stored by facility in order for the user to opt into the user notification program.

The context-aware user notification may be generated based on the current location of the user and in some embodiments, based on a user facility interaction prediction and displayed using a display associated with a facility device such that the content of the context-aware user notification may be relevant to the user's current location within the facility. The facility device may display the content of the context-aware user notification based on a display configuration set, which indicates parameters for pixels of the display such that the content is only viewable to the intended user. As such, the user may be securely presented with context-aware user notifications that contain location-relevant information for the user as they move throughout the facility.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for securely presenting context-aware user notifications, in accordance with some example embodiments described herein.

FIG. 2 illustrates a schematic block diagram of example circuitry embodying a system device of the user analytics system that may perform various operations in accordance with some example embodiments described herein.

FIG. 3 illustrates a schematic block diagram of example circuitry embodying a facility device and/or third-party device that may perform various operations in accordance with some example embodiments described herein.

FIG. 4 illustrates an example flowchart for securely presenting a context-aware notification to a user, in accordance with some example embodiments described herein.

FIG. 5 illustrates an example flowchart for determining a current user location, in accordance with some example embodiments described herein.

FIG. 6 illustrates an example flowchart for generating a display configuration set for a facility device, in accordance with some example embodiments described herein.

FIG. 7 illustrates an example flowchart for generating a context-aware notification based on a user facility interaction prediction for a facility device, in accordance with some example embodiments described herein.

FIG. 8 illustrates an example flowchart for generating a context-aware notification based on one or more user recommendations, in accordance with some example embodiments described herein.

FIG. 9 illustrates an example flowchart for generating a user participation request as performed by a facility device, in accordance with some example embodiments described herein.

FIG. 10 illustrates an example flowchart for providing one or more user engagement offer responses by a third-party device, in accordance with some example embodiments described herein.

FIGS. 11A, 11B, 11C, and 11D illustrate swim lane diagrams with example operations that may be performed by components of the environment depicted in FIG. 1, in accordance with some example embodiments described herein.

FIG. 12A illustrates a side-view profile schematic of a user with a facility device.

FIG. 12B illustrates a top-down profile schematic of a user with a facility device.

FIG. 13 illustrates an example context-aware user notification that may be securely displayed to a user using a facility device, as used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

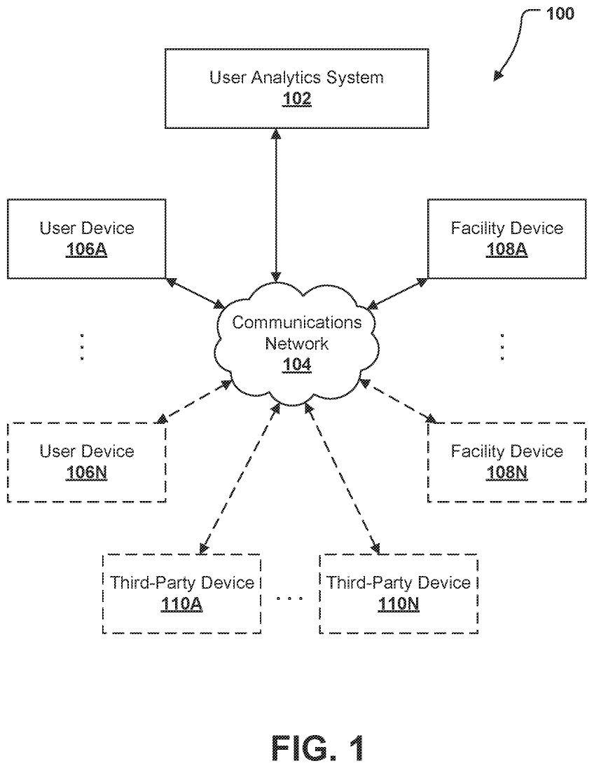

Example embodiments described herein may be implemented using any of a variety of computing devices or servers. To this end, FIG. 1 illustrates an example environment 100 within which various embodiments may operate. As illustrated, a user analytics system 102 may receive and/or transmit information via communications network 104 (e.g., the Internet) with any number of other devices, such as one or more of user devices 106A-106N, facility devices 108A-108N, and/or third-party devices 110A-110N.

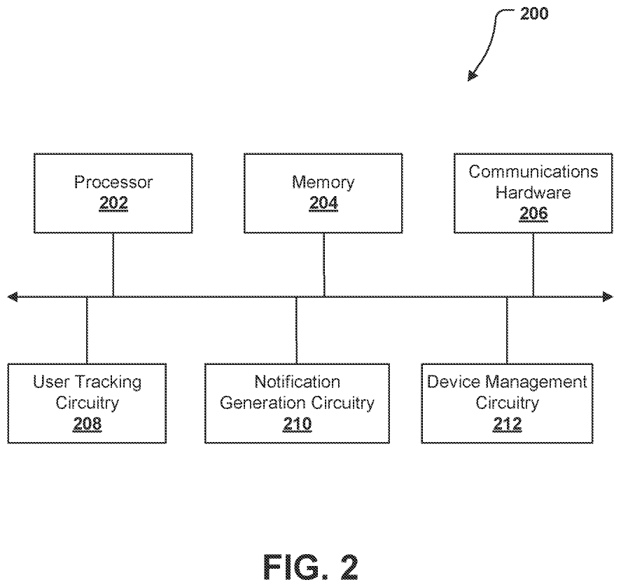

The user analytics system 102 may be implemented as one or more computing devices or servers, which may be composed of a series of components. Particular components of the user analytics system 102 are described in greater detail below with reference to apparatus 200 in connection with FIG. 2.

In some embodiments, the user analytics system 102 further includes a storage device 110 that comprises a distinct component from other components of the user analytics system 102. A storage device (not shown) may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The storage device may host the software executed to operate the user analytics system 102. The storage device may store information relied upon during operation of the user analytics system 102, such as various models, a temporal image set, a user participation request, a display configuration set, a context-aware user notification, a user position response, a pixel configuration set, an orientation position set, a facility object database, and/or the like that may be used by the user analytics system 102, data and documents to be analyzed using the user analytics system 102, or the like. In addition, storage device 106 may store control signals, device characteristics, and access credentials enabling interaction between the user analytics system 102 and one or more of the user devices 106A-106N, facility devices 108A-108N, and/or third-party devices 110A-110N.

The one or more user devices 106A-106N, one or more facility devices 108A-108N, and/or one or more third-party devices 110A-110N may be embodied by any computing devices known in the art. The one or more user devices 106A-106N, one or more facility devices 108A-108N, and/or one or more third-party devices 110A-110N need not themselves be independent devices, but may be peripheral devices communicatively coupled to other computing devices. In some embodiments, the one or more facility devices 108A-108N may be associated with a facility entity, which may correspond to the entity associated with the user analytics system 102 such that devices belong to the same system. In some embodiments, user analytics system 102 and the one or more facility devices 108A-108N may correspond over a private network and/or may have access to stored data between devices. In some embodiments, the one or more third-party devices 110A-110N may be associated with a third-party entity which is different than the facility entity.

Although FIG. 1 illustrates an environment and implementation in which the user analytics system 102 interacts indirectly with a user via one or more of one or more user devices 106A-106N, one or more facility devices 108A-108N, and/or one or more third-party devices 110A-110N, in some embodiments users may directly interact with the user analytics system 102 (e.g., via communications hardware of the user analytics system 102), in which case a separate user device (e.g., any one of user devices 106A-106N), facility device (e.g., any one of facility devices 108A-108N), and/or third-party device (e.g., any one of third-party devices 110A-110N) may not be utilized. Whether by way of direct interaction or indirect interaction via another device, a user may communicate with, operate, control, modify, or otherwise interact with the user analytics system 102 to perform the various functions and achieve the various benefits described herein.

### Example Implementing Apparatuses

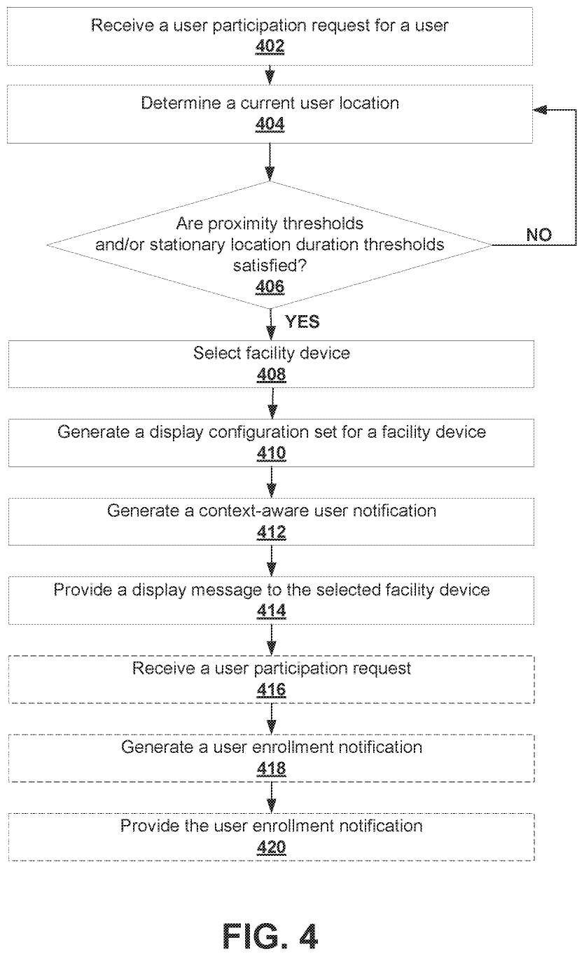

The user analytics system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-13. As illustrated in FIG. 2, the apparatus 200 may include processor 202, memory 204, communications hardware 206, user tracking circuitry 208, notification generation circuitry 210, and device management circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In some embodiments, the communications hardware 206 may be configured to receive a user participation request for a user, provide a display message to a facility device, provide a user position request to a facility device, receive a user position response, receive a user participation request, provide a user enrollment notification, receive one or more captured images over a timeframe, and/or receive one or more engagement offer responses. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises user tracking circuitry 208 that may be configured to determine a current user location, determine whether a user is included in one or more captured images, append captured images to a temporal image set, identify a captured image from the temporal image set which is associated with a most recent image timestamp, determine whether the most recent image timestamp satisfies one or more temporal thresholds, and/or determine a user stationary location duration. The user tracking circuitry 208 may utilize processor 202, memory 204, or any other hardware component included in the apparatus 200 to perform these operations, as described in connection with FIGS. 4-13 below. The user tracking circuitry 208 may further utilize communications hardware 206 to gather data from a variety of sources (e.g., user device 106A through user device 106N, facility device 108A through facility device 108N, third-party device 110A through third-party device 110N as shown in FIG. 1 and/or a storage device), and/or exchange data with a user.

In addition, the apparatus 200 further comprises a notification generation circuitry 210 that may be configured to generate a context-aware user notification, generate a user enrollment notification, query a facility object database, determine one or more user account parameters, determine one or more user recommendations, and/or generate one or more user engagement offer requests. The notification generation circuitry 210 may utilize processor 202, memory 204, or any other hardware component included in the apparatus 200 to perform these operations, as described in connection with FIGS. 4-13 below. The notification generation circuitry 210 may further utilize communications hardware 206 to gather data from a variety of sources (e.g., user device 106A through user device 106N, facility device 108A through facility device 108N, third-party device 110A through third-party device 110N as shown in FIG. 1 and/or a storage device), and/or exchange data with a user.

Further, the apparatus 200 further comprises a device management circuitry 212 that may be configured to generate a display configuration set, determine whether a current user location satisfies one or more proximity thresholds, select at least one facility device, generate a user position request, generate a pixel configuration set, determine a user orientation position set. The device management circuitry 212 may utilize processor 202, memory 204, or any other hardware component included in the apparatus 200 to perform these operations, as described in connection with FIGS. 4-13 below. The device management circuitry 212 may further utilize communications hardware 206 to gather data from a variety of sources (e.g., user device 106A through user device 106N, facility device 108A through facility device 108N, third-party device 110A through third-party device 110N as shown in FIG. 1 and/or a storage device), and/or exchange data with a user.

Although components 202-212 are described in part using functional language, it will be understood that the particular implementations necessarily include the use of particular hardware. It should also be understood that certain of these components 202-212 may include similar or common hardware. For example, the uses tracking circuitry 208, notification generation circuitry 210, and device management circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the user tracking circuitry 208, notification generation circuitry 210, and device management circuitry 212 may leverage processor 202, memory 204, or communications hardware 206 as described above, it will be understood that any of user tracking circuitry 208, notification generation circuitry 210, and device management circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that user tracking circuitry 208, notification generation circuitry 210, and device management circuitry 212 comprise particular machinery designed for performing the functions described herein in connection with such elements of apparatus 200.

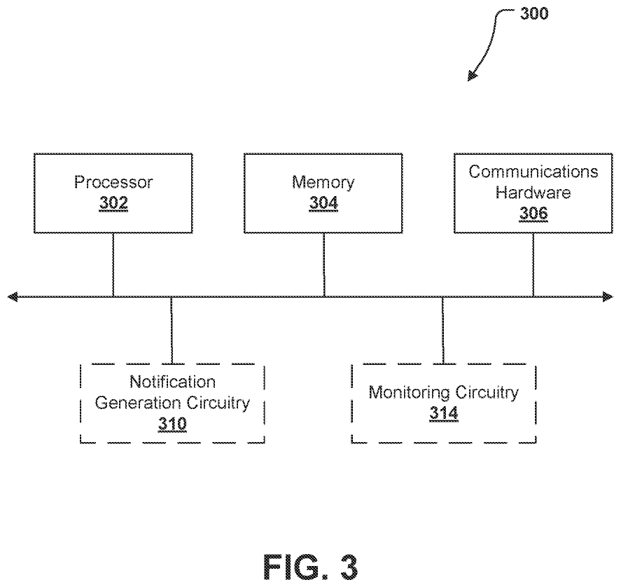

As illustrated in FIG. 3, an apparatus 300 is shown that represents an example facility device (e.g., any of facility devices 108A-108N) or an example third-party device (e.g., any of third-party devices 110A-110N). The apparatus 300 includes processor 302, memory 304, and communications hardware 306, and may optionally include notification generation circuitry 310, which may be configured to be similar to the similarly named components described above in connection with FIG. 2 (e.g., notification generation circuitry 210). In particular, the notification generation circuitry 310 may be configured to determine one or more user account parameters, generate one or more user recommendations, and/or generate one or more user engagement offer responses.

However, the apparatus 300 also includes monitoring circuitry 314, which includes hardware components designed for displaying a context-aware user notification based on a display configuration set. In particular, the monitoring circuitry 314 may be configured to cause the apparatus 300 to capture one or more user images, generate a user characteristic attribute set, generate a user identification request, generate a user identification attribute set, and generate a user participation request. The monitoring circuitry 314 may utilize processor 302, memory 304, or any other hardware component included in the apparatus 300 to perform these operations, as described in connection with FIGS. 4-13 below.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

### Example Operations of User Analytics System

Turning to FIGS. 4-8, example flowcharts are illustrated that contain example operations implemented by example embodiments described herein. The operations illustrated in FIGS. 4-8 may, for example, be performed by a system device of the user analytics system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, user tracking circuitry 208, notification generation circuitry 210, device management circuitry 212 and/or any combination thereof. It will be understood that user interaction with the user analytics system 102 may occur directly via communications hardware 206, or may instead be facilitated by a separate user device (e.g., one of user devices 106A-106N), facility device (e.g., one of facility devices 108A-108N), and/or third-party device (e.g., one of third-party devices 110A-110N) as shown in FIG. 1, and which may have similar or equivalent physical componentry facilitating such user interaction.

Turning first to FIG. 4, example operations are shown for securely presenting a context-aware notification to a user. In particular, a user may elect to participate in a user notification program that securely provides context-aware user notification to the user within a facility. To do so, the user may interact with a facility device, which may capture user characteristic attributes of the user and user identification attributes. As such, the user analytics system may track the user throughout the facility and for the duration of the user's time within the facility, the user may be presented with context-aware user notifications when they are within a particular proximity to a facility device such that the facility device may display the context-aware user notification to the user in a secure and private manner. The context-aware user notification may be generated based on the current location of the user and in some embodiments, based on a user facility interaction prediction and displayed using a display associated with a facility device such that the content of the context-aware user notification may be relevant to the user's current location within the facility. The facility device may display the content of the context-aware user notification based on a display configuration set, which indicates parameters for pixels of the display such that the content is only viewable to the intended user. As such, the user may be securely presented with context-aware user notifications that contain location-relevant information for the user as they move throughout the facility.

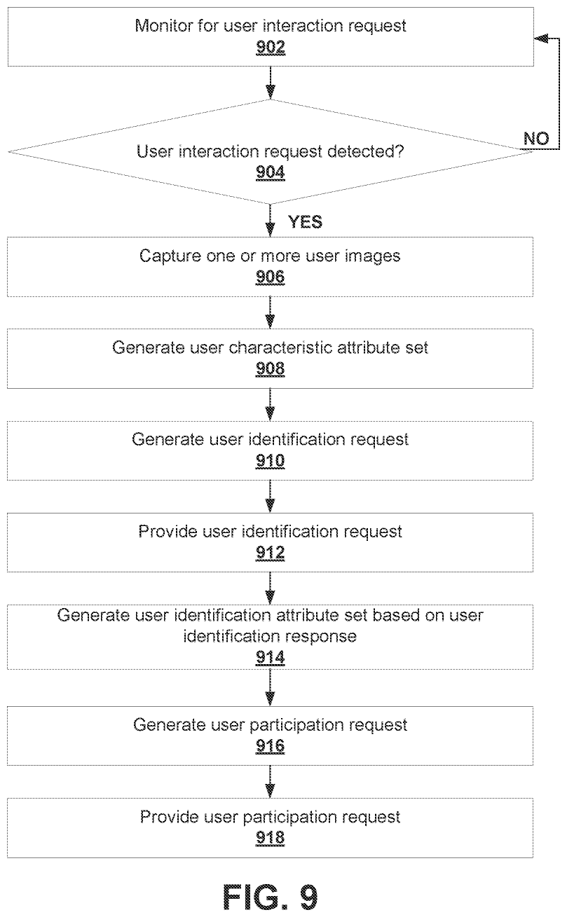

As shown by operation 402, the apparatus 200 includes means, such as processor 202, memory 204, communications hardware 206, or the like, for receiving a user participation request. In some embodiments, the user participation request is indicative that the user has opted-in to a user notification program such that the user requests to be presented with one or more context-aware user notifications throughout the duration of his or her visit at a facility. The user participation request may be received from a facility device (e.g., any one of facility devices 108A-108N) in response to user interaction with said facility device, as discussed in greater detail with respect to FIG. 9. The user participation request may include a user characteristic attribute set and a user identification attribute set. The user characteristic attribute set may aid in the identification and tracking of the user throughout the duration of the user's visit to the facility via one or more captured images. The user identification attribute set may aid in the generation of bespoke context-aware user notifications, which may include one or more user recommendations for the user from the facility and/or a third-party entity. The facility and/or third-party entity may use the user identification attribute set to determine one or more associated user account parameters for the user, which may be used to determine the one or more user recommendations.

In some embodiments, a user participation request may include a user characteristic attribute set. The user characteristic attribute set may include one or more user characteristic attributes which describe one or more attributes of the user associated with the user participation request. In some embodiments, a user characteristic attribute may describe an appearance, characteristic, or other identification metric of the user which may be used, along with other user characteristic attributes, to uniquely identify the user. For example, a user characteristic attribute may describe a clothing item color, a clothing item type, an eye color, a hair color, a skin tone, an accessory (e.g., purse, bag, or other item), a height, a shape, other identifying characteristics of the user. As described below in FIG. 9, the one or more user characteristic attributes may be determined based on one or more captured images (e.g., captured pictures and/or individual video frames from a video stream) of the user by the facility device. The one or more user characteristic attributes may be used by apparatus 200 (e.g., by user tracking circuitry 208) to track or monitor a user location of the user throughout the facility. Additionally, by using user characteristic attributes to track or monitor the user location, even in an instance the user moves into a location not monitored by a facility device such that a current user location is not known, once the user moves back into a location that is monitored by a facility device, apparatus 200 may recognize and identify a candidate user as the user based on the one or more user characteristic attributes.

Additionally, apparatus 200 may only utilize, store, or otherwise maintain the one or more user characteristic attributes in the user characteristic attribute set for the duration the user is within the facility. Apparatus 200 may delete the user characteristic attribute set for a user after the user location cannot be determined for a predetermined time period (e.g., after thirty minutes, one day, one week, etc.). As such, this may be indicative that the user has left the facility such that there is no longer a need to monitor the user location and therefore, the user characteristic attribute set is no longer needed. As opposed to conventional tracking systems which may use biometric data, the use of a user characteristic attribute set further advantageously allows for any user to opt into the user notification program and does not require that the user be registered with a user profile associated with apparatus 200. As such, biometric data of the user need not be stored by apparatus 200 in order for the user to opt into the user notification program.

In some embodiments, a user participation request may include a user identification attribute set. The user identification attribute set may comprise one or more user identification attributes which describe one or more identification attributes of the user and/or user device associated with the user participation request. In some embodiments, a user identification attribute may describe one or more values associated with the user which may be used by apparatus 200 and/or a third-party device (e.g., any of one of third-party devices 110A-110N). For example, a user identification attribute may be a username, phone number, email address, account number, card number (e.g., credit card, debit card, loyalty card, etc.), driver's license, user device identification number (e.g., international mobile equipment identity (IMEI), serial number, etc.), user device information (e.g., make, model, version, device name, etc.), and/or the like. As described below in FIG. 9, the one or more user identification attributes may be determined based on one or more user interactions by the user with the facility device. For example, the user may swipe an associated card, key, badge, device, and/or the like to provide the facility device with the one or more user identification attributes.

As shown by operation 404, the apparatus 200 includes means, such as processor 202, memory 204, communications hardware 206, user tracking circuitry 208 or the like, for determining a current user location. Once the apparatus 200 receives the user participation request for the user, apparatus 200 may determine that the user has opted into the user notification program and may continuously monitor the user's current location during the duration of the user's visit to the facility. As described above, the apparatus 200 may monitor the user's current location within the facility until the user location cannot be determined for a predetermined time period (e.g., after thirty minutes, one day, one week, etc.), which may be indicative that the user has left the facility. In particular, the user tracking circuitry 208 may use the one or more characteristics described by the user characteristic attribute set along with a temporal image set to determine the current user location.

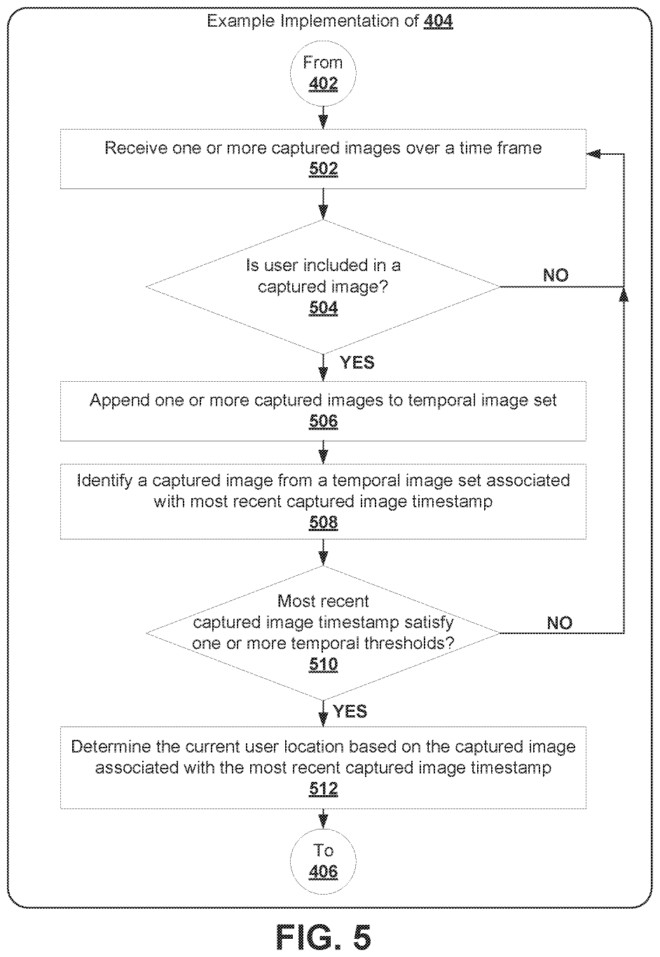

The temporal image set may comprise one or more captured images that are determined to include the user, as discussed in greater detail in FIG. 5. Each captured image in the temporal image set may be associated with a captured image timestamp indicative of the time the image was captured such that the most recent location of the user may be determined. Additionally, each captured image may be associated with a facility device identifier and each facility identifier may be associated with a facility device location indicative of the location of the facility device and an image capture location radius indicative of a corresponding location within the facility depicted in the captured image. As such, the user tracking circuitry 208 may identify the location where the most recent captured image that included the user occurred and thus, the current location of the user may be identified. The user tracking circuitry 208 may continuously update the current user location based on the captured image associated with the most recent captured image timestamp and the associated facility device identifier associated with the most recent captured image.

In some embodiments, operation 404 may be performed in accordance with the operations described by FIG. 5. Turning now to FIG. 5, example operations are shown for determining a current user location.

As shown by operation 502, the apparatus 200 includes means, such as processor 202, memory 204, communications hardware 206, or the like for receiving one or more captured images over a time frame. In particular, a captured image may be a captured picture, an individual video frame from a video stream, a video stream and/or the like. The communications hardware 206 may be configured to receive the one or more captured images over a particular time frame. In some embodiments, the time frame over which the communications hardware 206 is configured to receive the one or more captured images may be the hours of operation of the facility. As another example, the time frame may begin upon receipt of the user participation request for the user and end after a user location cannot be determined for a predetermined time period (e.g., thirty minutes, one hour, one day, etc.).

The one or more captured images may be received from one or more facility devices (e.g., facility devices 108A-108N) periodically or semi-periodically. For example, the communications hardware 206 may be configured to receive one or more captured images from each particular facility device every five seconds. In some embodiments, the one or more captured images are a video stream such that the communications hardware 206 may be configured to receive a captured image from a facility device continuously. As described above, each captured image may be associated with a captured image timestamp indicative of the time the image was captured by the corresponding facility device. As such, the time each captured image was captured, taken, determined, and/or the like may be determined.

Additionally, each captured image may be associated with a facility device identifier. The facility identifier may correspond to a particular facility device and may be associated with a facility device location indicative of the location of the facility device within the facility and an image capture location radius which is indicative of a corresponding location within the facility depicted in the captured image. For example, a particular facility identifier may be associated with an image capture location radius that spans the northwest corner of a facility and includes a particular set of coordinates. The particular set of coordinates may be absolute coordinates (e.g., global positioning system (GPS) coordinates) or relative coordinates, which may be determined based on a coordinate system of the facility. The facility identifier may also be associated with a configuration set indicative of the one or more configuration parameters of the facility device. For example, a configuration parameter may include a placement orientation, a placement height, a placement location, a lens type, a zoom setting, an aperture size, shutter speed, ISO, frame rate, resolution, log setting, white balance setting, and/or the like for the corresponding facility device. As such, the image capture location radius may be determined for the facility device based on the associated configuration set. For example, the position configuration parameter may be used to determine a location of the facility device within the facility, the orientation configuration parameter may be used to determine a direction the facility device is facing, and the lens type and/or zoom setting may be used to determine the field of view of the facility device. As such, the capture location radius for the facility device may be determined.

As shown by operation 504, the apparatus 200 includes means, such as processor 202, memory 204, communications hardware 206, user tracking circuitry 208, or the like for determining whether the user is included in each captured image of the one or more captured images. The user tracking circuitry 208 may be configured to process the one or more captured images as the captured images are received such that an accurate current user location may be determined. For example, although the one or more captured images may be received over a time frame, the user tracking circuitry 208 may process the one or more captured images in real-time or near real-time. The user tracking circuitry 208 may be configured to process the one or more captured images to determine whether the user associated with the user participation request is included in each received captured image. In some embodiments, the user tracking circuitry 208 may use one or more image processing models to determine whether the user is included in a captured image. An image processing model may use any suitable image processing techniques to process the one or more captured images. In some embodiments, the image processing model may be a machine learning model (e.g., a convolutional neural network and/or deep learning model) trained to process the one or more captured images and/or characteristic attribute set, identify one or more objects within each captured image, and determine whether an identified object within a captured image corresponds to the user. In particular, the image processing model may use computer vision techniques that may identify objects within the one or more captured images and may further, classify each identified object. In particular, the image processing model may be trained to recognize and identify users within a facility as objects and then may classify each object using Boolean values (e.g., true if object identified as the user or false if the object is not identified as the user), numerical values (e.g., 1 if object identified as the user or 0 if the object is not identified as the user), or categorical values (e.g., “user” category if object identified as the user or “not user” category if the object is not identified as the user), such that the classification is indicative of whether the object is the user.

In some embodiments, the image processing model may be configured to compare the one or more user characteristic attributes of the user characteristic attribute set to identified attributes of each identified object in a captured image. The image processing model may be configured to determine a user identification similarity score for each object based on a comparison of the object and its corresponding attributes to the one or more user characteristic attributes. The user identification similarity score may be indicative of an inferred similarity between the object and the one or more user characteristic attributes. In an instance in which the user identification similarity score satisfies one or more user identification similarity score thresholds, the image processing model may classify the object as “the user”. Otherwise, the image processing model may classify the object as “not the user”.

Each captured image may be classified based on the classification of the one or more identified objects within the corresponding captured image. Each captured image may be classified using Boolean values (e.g., true if captured image includes the user or false if the captured image does not include the user), numerical values (e.g., 1 if captured image includes the user or 0 if the captured image does not include the user), or categorical values (e.g., “user included” if captured image includes the user or “user not included” if the captured image does not include the user), such that the classification is indicative of whether the captured image includes an object identified as the user. For example, a captured image that includes identified objects which were each classified as the “not the user” may be classified as “user not included”. As another example, a captured image that includes an identified object which was classified as “the user” and optionally, one or more identified objects which were classified as “not the user” may be classified as “user included”.

In an instance in which the user is not included in any captured image, the process may proceed to operation 502, where the communications hardware 206 may receive additional captured images. In an instance in which the image processing model determines that no captured images are classified to include the user, the user tracking circuitry 208 may process newly received captured images to determine if one or more of these captured images include the user. As such, the user tracking circuitry 208 may continue to monitor for the user within the facility and therefore, may determine an accurate user location.

In an instance in which the user is included in one or more captured images, the process may proceed to operation 506. As shown by operation 506, the apparatus 200 includes means, such as processor 202, memory 204, communications hardware 206, user tracking circuitry 208, or the like for appending the one or more captured images determined to include the user to a temporal image set. In an instance in which the user tracking circuitry 208 determines the user is included in the captured image as described above using the one or more image processing models, the user tracking circuitry 208 may append the corresponding captured image to a temporal image set. The temporal image set may include one or more captured images determined and/or classified as including the user. In some embodiments, the one or more captured images included in the temporal image set may be ordered based on an associated captured image timestamp. In particular, the captured images may be ordered such that the captured image associated with the most recent captured image timestamp is positioned first, the captured image associated with the second most recent captured image timestamp is positioned second, and so forth. As such, the captured image associated most recently captured may be easily identified from the temporal image set.

As shown by operation 508, the apparatus 200 includes means, such as processor 202, memory 204, communications hardware 206, user tracking circuitry 208, or the like for identifying a captured image from the temporal image set associated with the most recent image timestamp. As described above, each captured image included in the temporal image set is associated with a captured image timestamp such that the user tracking circuitry 208 may identify the captured image timestamp associated with the most recent captured image timestamp. Furthermore, in some embodiments, the one or more captured images included in the temporal image set may be ordered based on their associated captured image timestamp such that the user tracking circuitry 208 may select the first (or last depending on ordering) captured image included in the captured image set.

As shown by operation 510, the apparatus 200 includes means, such as processor 202, memory 204, communications hardware 206, user tracking circuitry 208, or the like for determining whether the most recent timestamp satisfies one or more temporal thresholds. In order to determine whether the captured image associated with the most recent captured image timestamp has occurred recently such that the location of the user depicted in the captured image is accurate, the user tracking circuitry 208 may determine whether the most recent captured image timestamp satisfies one or more temporal thresholds. For example, a temporal threshold describe a value of 30 seconds such that the captured image timestamp associated with the most recent captured image must have occurred within 30 seconds or less of the current time in order to satisfy the temporal threshold. Otherwise, the captured image timestamp may fail to satisfy the temporal threshold.

In an instance in which the most recent timestamp fails to satisfy one or more temporal thresholds, the process proceeds to operation 502, where the communications hardware 206 may receive additional captured images. In an instance in which the image processing model determines the most recent captured image timestamp fails to satisfy the one or more temporal thresholds, this may indicate that the most recent image of the user is outdated and therefore not indicative of the current user location. This may occur in instances in which the user moves out of the way of the field of view of the one or more facility devices. The user tracking circuitry 208 may then continue to monitor for the user within the facility and receive one or more new captured images at operation 502. These one or more new captured images may include the user, such as in an instance in which the user has re-entered the field of view of one or more facility devices.

In an instance in which the most recent timestamp satisfies one or more temporal thresholds, the process proceeds to operation 512. As shown by operation 512, the apparatus 200 includes means, such as processor 202, memory 204, communications hardware 206, user tracking circuitry 208, or the like for determining the current user location based on the captured image associated with the most recent image timestamp. Once the user tracking circuitry 208 has identified and/or determined the most recent captured image that satisfies the one or more temporal thresholds, the user tracking circuitry 208 may further process said captured image to determine the current user location.

As described above, each captured image may be associated with a facility device identifier and the facility identifier may be associated with an image capture location radius which is indicative of a corresponding location within the facility depicted in the captured image. The user tracking circuitry 208 may be configured to use a user location determination model to determine a current user location. In particular, the user location determination model may use any suitable image processing techniques to process the captured images and identify a relative position of the user included in the captured image. In some embodiments, the user location determination model may be a machine learning model (e.g., a convolutional neural network and/or deep learning model) trained to process the captured image and determine a relative position of the object identified as the user within the captured image. In particular, the user location determination model may use computer vision techniques to identify a relative user position within the captured image and may further, use the image capture location radius associated with the facility device associated with the captured image to determine the current user location. In some embodiments, the current user location includes a particular set of coordinates such as absolute coordinates (e.g., global positioning system (GPS) coordinates) and/or relative coordinates determined based on a coordinate system of the facility. As such, the current user location within the facility may be determined. Additionally, based on the current user location, the proximity of the user to one or more other objects within the facility, such as one or more facility devices and/or facility objects (e.g., certain products, customer service areas, check-out lines, wait areas, and/or the like) which may be known.

Returning now to FIG. 4, as shown by operation 406, the apparatus 200 includes means, such as processor 202, memory 204, communications hardware 206, user tracking circuitry 208, device management circuitry 212, or the like, for determining whether one or more proximity thresholds and/or stationary location duration thresholds are satisfied.

Once the current user location is determined, the device management circuitry 212 may determine the proximity of the user to one or more facility devices. Each facility device identifier may be associated with a facility device location indicative of the location of facility device. The facility device location may also include a set of coordinates such as absolute coordinates (e.g., global positioning system (GPS) coordinates) and/or relative coordinates determined based on a coordinate system of the facility. The device management circuitry 212 may compare the current user location to a facility device location for one or more facility devices to determine whether one or more proximity thresholds are satisfied. A proximity threshold value may be set based on an inferred viewable distance of the facility device. For example, a facility device may be a 11-inch monitor capable of displaying content and a proximity threshold may be 2 feet, which may be determined based on a recommended viewing distance of 2 times the diagonal width of the screen. As such, in an instance in which the device management circuitry 212 determines that the current location of the user is within 2 feet or less of the location of the facility device, the device management circuitry 212 may determine the current user location satisfies the one or more proximity thresholds. Otherwise, in an instance in which the device management circuitry 212 determines that the current location of the user is greater than 2 feet from the location of the facility device, the device management circuitry 212 may determine the current user location fails to satisfy the one or more proximity thresholds. As such, the device management circuitry 212 may verify that the user is located within a suitable distance of a facility device such that the user would be able to view content display by said facility device.

Additionally or alternatively, the user tracking circuitry 208 may determine a user stationary location duration for the user. The value of the user stationary location duration may be indicative of the length of time the user has remained at a particular location or within a location proximity threshold (e.g., within a particular distance from a location). In particular, the user tracking circuitry 208 may identify a user location for each captured image included in the temporal image set and then determine the user stationary location duration for the user based on the associated captured image timestamps for one or more captured images which are associated with a user location at a same particular location and/or within a particular location proximity. For example, a first captured image included in the temporal image set may be associated with a current user location of x and y, where x is a first coordinate in a coordinate set and y is a second coordinate in the coordinate set. The user tracking circuitry 208 may determine the next n number of captured images which include the user location of x and y. Alternatively, the user tracking circuitry 208 may determine x′ and y′, where x′ is a first coordinate within a proximity from x and y′ is a second coordinate within a proximity from y. In an instance x′ is within a location proximity threshold (e.g., 1 foot) of x and/or y′ is within a location proximity threshold (e.g., 1 foot) of y, the user tracking circuitry 208 may determine the user has remained within the location proximity threshold. The user tracking circuitry 208 may determine the user stationary location duration by determining a difference between the captured image timestamp of the captured image associated with the current user location and captured image timestamp of the least recent captured image in which the user has remained at the particular location or within a location proximity threshold from the current user location.

The user tracking circuitry 208 may then determine whether the stationary location duration satisfies one or more stationary location thresholds. For example, a stationary location threshold value may be set based on a timing threshold that may indicate user interest nearby the facility device. For example, stationary location duration threshold may be 10 seconds such that in an instance in which the user tracking circuitry 208 determines that the stationary location duration of the user is greater or equal to 10 seconds, the user tracking circuitry 208 may determine the stationary location duration satisfies the one or more stationary location duration thresholds. Otherwise, in an instance in which the user tracking circuitry 208 determines that the stationary location duration of the user is less than 10 seconds, the user tracking circuitry 208 may determine the stationary location duration fails to satisfy the one or more stationary location duration thresholds. As such, the user tracking circuitry 208 may verify that the user has displayed an interest in a particular location within a facility such that the user may be interested in a context-aware user notification that is generated based in part on the current user location.

In an instance in which one or more of the one or more proximity thresholds and/or stationary location duration thresholds fail to be satisfied, the process may proceed to operation 404, where the current user location may be updated. The above-described process may then be repeated for the user based on an updated current user location.

In an instance in which one or more of the one or more proximity thresholds and/or stationary location duration thresholds are satisfied, the process may proceed to operation 408. As shown by operation 408, the apparatus 200 includes means, such as processor 202, memory 204, communications hardware 206, device management circuitry 212 or the like, for selecting a facility device. Once the device management circuitry 212 and/or user tracking circuitry 208 has determined one or more proximity thresholds and/or stationary location duration thresholds are satisfied, the device management circuitry 212 may select a facility device. The selected facility device may correspond to the facility device that the current user location was determined to satisfy the one or more proximity thresholds for, as described in operation 406.

In some embodiments, the selected facility device may correspond to a particular facility device type. For example, in some embodiments, the facility device identifier may further be associated with a facility device type which describes the type of facility device. A facility device type may further be indicative of the capabilities of the facility device. For example, a facility device type may be a display monitor, a security camera, a check-out scanner, a card payment reader, a user participation request generator, and/or the like. In some embodiments, the device management circuitry 212 may select only facility devices associated with a display monitor facility device type and that the current user location is determined to satisfy the one or more proximity thresholds for.

As shown by operation 410, the apparatus 200 includes means, such as processor 202, memory 204, communications hardware 206, device management circuitry 212, or the like, for generating a display configuration set for a facility device. In some embodiments, the facility device selected may be configured with parallel reality technology such that it is capable of outputting a plurality of controllable rays of different colors and/or brightness. In particular, each pixel of a plurality of pixels belonging to the facility device may be configured to simultaneously output unique rays of an associated color and/or brightness. As such, the facility device may be capable of simultaneously displaying different content for different users depending on the user's location and angle of viewing. As such, a user standing at one particular position may be able to view content displayed by the facility device while another user standing at a slightly different position may be able simultaneously view different content displayed by the same facility device, but the two users may not be able to view the other's content. Additionally, the display configuration set may include one or more other parameters, such as a display time for provided content, display style parameters (e.g., color, font size, font style, and/or the like), and/or the like.

In order to securely display content (e.g., content of the context-aware user notification) to the user such that the content is solely viewable by the user and not other parties, the device management circuitry 212 may determine a display configuration set indicative of instructions for a facility device for displaying the context-aware user notification. In particular, the display configuration set may include a pixel configuration set which describes instructions for one or more of a wavelength, power, brightness, and/or orientation for a pixel set associated with the facility device. These parameters may control the direction of output rays of each pixel in the pixel set. The pixel set may include one or more pixels of the plurality of pixels of the facility device. The pixel configuration set may thus provide instructions to the facility device for displaying information, such as a context-aware user notification setting to only the intended user such and such that it is not viewable by other users.

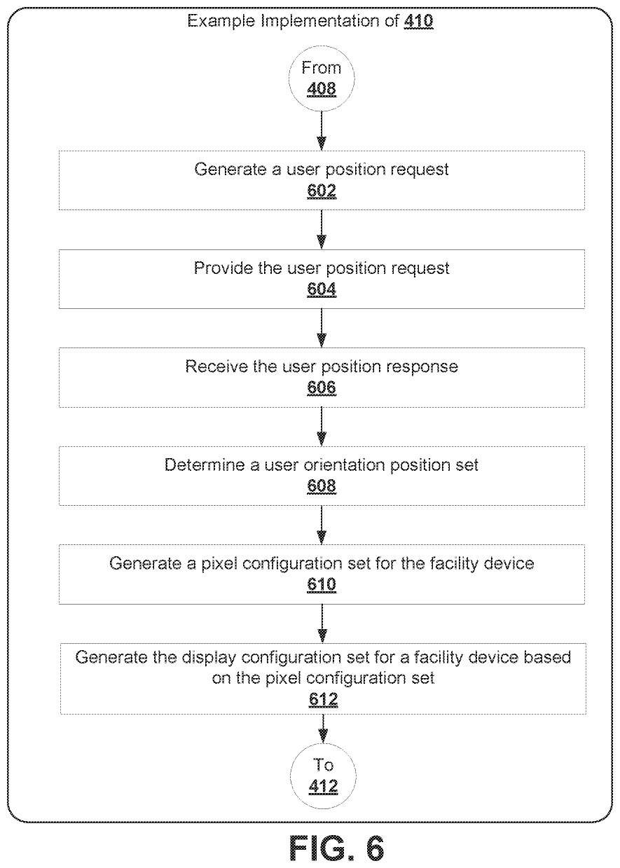

In some embodiments, operation 410 may be performed in accordance with the operations described by FIG. 6. Turning now to FIG. 6, example operations are shown for generating a display configuration set for the facility device.

As shown by operation 602, the apparatus 200 includes means, such as processor 202, memory 204, communications hardware 206, device management circuitry 212, or the like for generating a user position request. While the current user location may be known, in order to ensure the facility device only displays content to the user, the device management circuitry 212 may generate a user position request. The user position request may include instructions for the facility device to capture one or more proximate captured images from the facility device. In some embodiments, the selected facility device may be configured with a camera such that it is capable of capturing one or more proximate captured images that include the user. These one or more proximate captured images may be indicative of a relative position of the user with respect to the facility device such that an accurate pixel configuration set may be determined for the facility device. Alternatively, the selected facility device may be associated with another facility device that is proximate the facility device. The another facility device may be configured with a camera in an instance in which the selected facility device is not and the another facility device may be configured to provide a user position response on behalf of the selected facility device.

As shown by operation 604, the apparatus 200 includes means, such as processor 202, memory 204, communications hardware 206, or the like for providing the user position request. The communications hardware 206 may provide the user position request to the selected facility device and/or associated facility device and may wait for a user position response in response to the user position request.

As shown by operation 606, the apparatus 200 includes means, such as processor 202, memory 204, communications hardware 206, or the like for receiving a user position response. The communications hardware 206 may receive the user position response, which may include the one or more user proximate captured images. The one or more user proximate captured images may include captured pictures, individual video frames from a video stream, and/or a video stream as captured by the selected facility device or the associated facility device.

As shown by operation 608, the apparatus 200 includes means, such as processor 202, memory 204, communications hardware 206, device management circuitry 212, or the like for determining a user orientation position set. The device management circuitry 212 may process the one or more user proximate captured images using an orientation image processing model. An orientation image processing model may use any suitable image processing techniques to process the one or more user proximate captured images. In some embodiments, the orientation image processing model may be a machine learning model (e.g., a convolutional neural network and/or deep learning model) trained to process the one or more user proximate captured images to determine a user orientation position set for the user. The user orientation position set may include a user distance relative to the facility device, a user vertical orientation relative to a vertical reference plane of the facility device, and/or a user horizontal orientation relative to a horizontal reference plane of the facility device. In some embodiments, the orientation image processing model may be configured to additionally process one or more configuration parameters of the facility device which provided the one or more user proximate captured images (e.g., the selected facility device or an associated facility device) such that a more accurate orientation and/or position of the user relative to the selected facility device may be determined. In some embodiments, the orientation image processing model may be configured to process the user characteristic attribute set and further identify the user associated with the user participation request from one or more other users as discussed above with respect to FIG. 5.

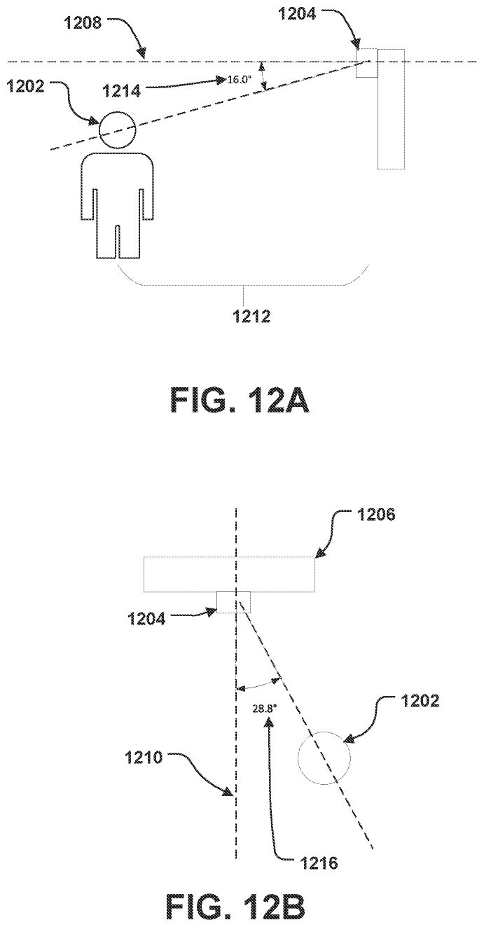

FIG. 12A depicts an example side profile a user 1202 and a facility device 1204 that is configured with a camera. The horizontal reference plane 1208 may extend as a horizontally flat plane from the facility device 1204. Then a user horizontal orientation 1214 may be determined for the user 1202 relative to the horizontal reference plane 1208. Additionally, the user distance 1212 of the user relative to the facility device 1204 is the distance between the user 1202 and the facility device 1204.

Similarly, FIG. 12B depicts an example top down view of the same user 1202 at the same current user location and the same facility device 1204. Here, the vertical reference plane 1210 may extend as a vertically flat plane from the facility device 1204. Then a user vertical orientation 1216 may be determined for the user 1202 relative to the vertical reference plane 1210.

As shown by operation 610, the apparatus 200 includes means, such as processor 202, memory 204, communications hardware 206, device management circuitry 212, or the like for generating a pixel configuration set for the selected facility device. Once the device management circuitry 212 has determined a user orientation position set, the device management circuitry 212 may generate the pixel configuration set for the selected facility device. In particular, the device management circuitry 212 may determine the one or more pixel configurations (e.g., wavelength, power, brightness, and/or orientation, etc.) included in the pixel configuration set based on the particular user orientation position set such that only the user positioned at the particular user distance, user vertical orientation, and/or user horizontal orientation may view user-specific content (e.g., context-aware user notifications) displayed by the facility device.

As shown by operation 612, the apparatus 200 includes means, such as processor 202, memory 204, communications hardware 206, device management circuitry 212, or the like for generating the display configuration set for the facility device based on the pixel configuration set. As described above, the device management circuitry may generate the display configuration set for the facility device such that the display configuration set includes the pixel configuration set. Additionally, the display configuration set may include one or more other parameters, such as a display time for provided content, display style parameters (e.g., color, font size, font style, and/or the like), and/or the like.

Returning now to FIG. 4, as shown by operation 412, the apparatus 200 includes means, such as processor 202, memory 204, communications hardware 206, notification generation circuitry 210, or the like, for generating a context-aware user notification. The notification generation circuitry 210 may generate the context-aware user notification based on the user current user location and the user identification set. The user identification attribute set may include one or more user identification attributes which pertain to the user. The one or more user identification attributes may aid in the identification of associated user account parameters for the user. For example, user identification attributes may include a username, phone number, email address, account number, card number (e.g., credit card, debit card, loyalty card, etc.), driver's license, user device identification number (e.g., IMEI, serial number, etc.), user device information (e.g., make, model, version, device name, etc.), and/or the like. Associated user account parameters may then be determined for the user using the one or more user identification attributes. For example, the notification generation circuitry 210 may use the one or more user identification attributes to identify a corresponding user profile associated with the user analytics system 102, which includes one or more associated user account parameters of the user. Additionally or alternatively, a third-party device (e.g., any one of third-party devices 110A-110N) may use the one or more user identification attributes to identify a corresponding user profile associated with a network associated with the third-party device, which includes one or more associated user account parameters of the user. In either instance, one or more user recommendations may be generated for the user and these one or more user recommendations may be included in the context-aware user notification.

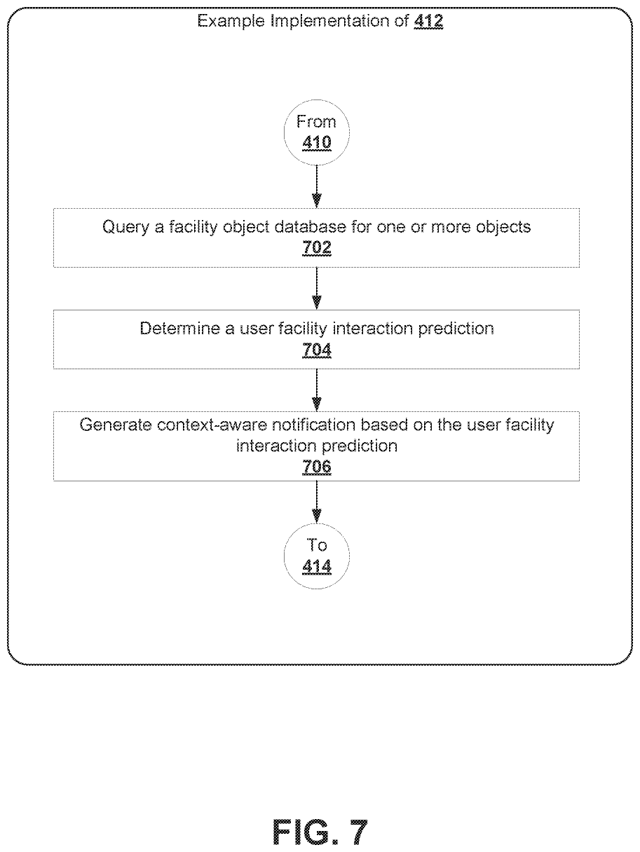

Additionally, in some embodiments, the current location of the user may also be used to generate the context-aware user notification. In particular, a user facility interaction prediction may be determined for the user based on the current user location and based on one or more objects determined to be within an interaction proximity threshold of the current user location. As such, the context-aware user notification may be directed towards a predicted user interaction with one or more objects within the facility. The generation of a user facility interaction prediction is discussed in greater detail in FIG. 7.

In some embodiments, operation 412 may be performed in accordance with the operations described by FIG. 7. Turning now to FIG. 7, example operations are shown for generating a context-aware notification based on a user facility interaction prediction.

As shown by operation 702, the apparatus 200 includes means, such as processor 202, memory 204, communications hardware 206, notification generation circuitry 210, or the like for querying a facility object database for one or more objects. In particular, the notification generation circuitry may query the facility object database for one or more objects which are determined to be within an interaction proximity threshold of the current user location.

A facility object database may be configured to store and/or maintain one or more objects which are included in the facility. For example, the one or more objects within a facility may include certain products, customer service areas, check-out lines, wait areas (e.g., areas users must wait in to access a particular object) and/or the like. The facility object database may also include a corresponding location for each object as well as one or more attributes for each object. For example, an attribute may include an object type (e.g., product, customer service area, check-out line, etc.). One or more other attributes may depend on the object type. For example, attributes for a product object type may include a make, model, dimensions, specifications, price, price reduction, current offers, available discounts, and/or the like. As another example, attributes for a customer service area object type and/or check-out line object type may include an estimated wait time, an open time, a close time, etc. In some embodiments, the location of objects may include a set of absolute coordinates (e.g., global positioning system (GPS) coordinates) and/or a set of relative coordinates. In some embodiments, the location of objects may further include an encompassed area. The encompassed area may span a particular distance from the set of coordinates associated with the object (e.g., 3 feet from the set of coordinates). As such, larger objects or objects in which users may be waiting to interact with (e.g., check-out line object types and/or customer service area object types) may be considered with a larger location area such that these objects may be captured within an interaction proximity threshold even if the current user location is slight distant from these objects (e.g., due to waiting in line).

An interaction proximity threshold may be an area centered about the current user location within which a user may wish to interact with an object. For example, an interaction proximity threshold may be within 5 feet of the current user location. As such, objects which are associated with a location within 5 feet or less from the current user location may be determined to be within the user proximity threshold.

As shown by operation 704, the apparatus 200 includes means, such as processor 202, memory 204, communications hardware 206, notification generation circuitry 210, or the like for determining a user facility interaction prediction. Once the notification generation circuitry 210 determines one or more objects which are determined to be within the interaction proximity threshold, the notification generation circuitry may determine a user facility interaction prediction. The user facility interaction prediction may be indicative of a predicted interaction of a user with a particular object. For example, a user facility interaction may describe a user facility interaction prediction of a purchase with a particular television (e.g., product object type) determined to be within the interaction proximity threshold. A facility interaction may include an object purchase, a checkout, a return, an exchange, an object-specific interaction (e.g., interaction with an ATM, coin exchange machine, etc.), and/or the like.

In some embodiments, the notification generation circuitry may use one or more interaction prediction models to determine the user facility interaction prediction. An interaction prediction model may be a rules-based or machine-learning model that is trained to process one or more objects determined to be within the interaction proximity threshold and the one or more attributes of the objects to generate a user facility interaction prediction for the user. The interaction prediction model may be trained on historical data labelled with previous user interactions with particular objects of a corresponding object type such that the interaction prediction model is trained to recognize and/or classify patterns of user interaction with objects of certain object types. Additionally, in some embodiments, the interaction prediction model may further be provided with a user stationary location duration such that the length of time the user has remained about the current user location may further be considered. The interaction prediction model may use any suitable technique to process the one or more objects, one or more object attributes, and/or the user stationary location duration, such as statistical techniques for pattern recognition and classification, k-means clustering, k-nearest neighbor, centroid-based clustering, density-based clustering, distribution-based clustering, hierarchical clustering, and/or the like.

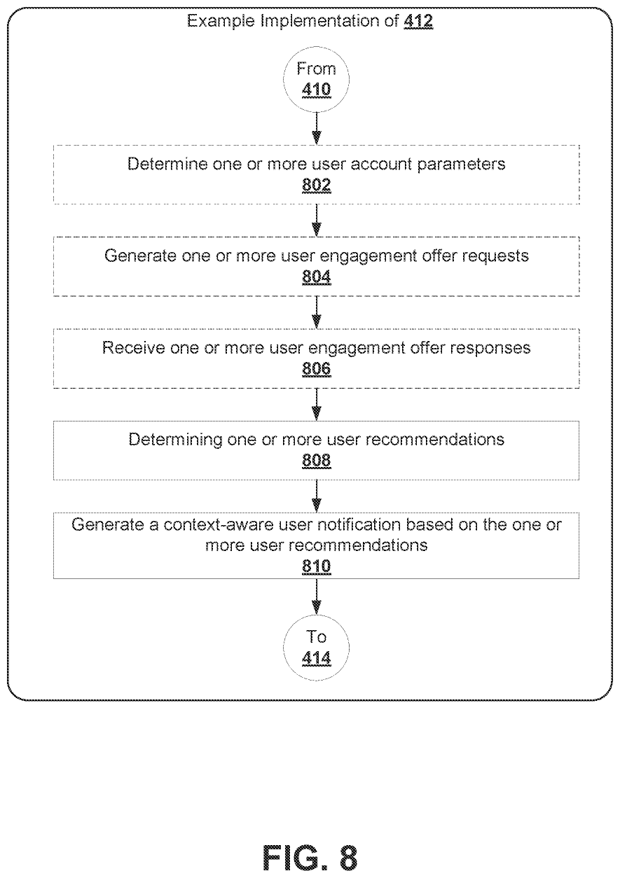

As shown by operation 706, the apparatus 200 includes means, such as processor 202, memory 204, communications hardware 206, notification generation circuitry 210, or the like for generating a context-aware notification based on the user facility interaction prediction. Once the notification generation circuitry 210 has generated the facility interaction prediction, the notification generation circuitry 210 may generate the context-aware notification to include the one or more objects associated with the facility interaction prediction and/or the facility interaction prediction. The context-aware notification may be generated to include one or more attributes of the object (e.g., make, model, dimensions, specifications, price, price reduction, current offers, available discounts, estimated wait time, an open time, a close time, etc.). For example, the context-aware notification may be generated to include one or more attributes of a television product and a question regarding whether the user is interested in purchasing this particular television. As another example, the context-aware notification may be generated to include one or more attributes of a wait area associated with ATMS (e.g., estimated wait times) and an instruction to proceed to a particular ATM. In some embodiments, the user facility interaction prediction may be used to generate one or more user recommendations, as described in greater detail in FIG. 8.

Additionally or alternatively, in some embodiments, operation 412 may be performed in accordance with the operations described by FIG. 8. Turning now to FIG. 8, example operations are shown for generating a context-aware notification based on one or more user recommendations. In some embodiments, the apparatus 200 may generate the one or more user recommendations for the user. Additionally or alternatively, a third-party system associated with a third-party device (e.g., any one of third-party devices 110A-110N) may be used to generate the one or more user recommendations for the user and may provide said user recommendations to the apparatus 200 for generation of the context-aware user notification.

Optionally, as shown by operation 802, the apparatus 200 includes means, such as processor 202, memory 204, communications hardware 206, notification generation circuitry 210, or the like for determining one or more user account parameters. As described above, the apparatus 200 may determine the one or more user account parameters using the notification generation circuitry 210. The notification generation circuitry 210 may determine the one or more user account parameters based on the user identification attribute set. As described above, the user identification attributes may include a username, phone number, email address, account number, card number (e.g., credit card, debit card, loyalty card, etc.), driver's license, user device identification number (e.g., IMEI, serial number, etc.), user device information (e.g., make, model, version, device name, etc.), and/or the like. Associated user account parameters may then be determined for the user using the one or more user identification attributes. For example, the notification generation circuitry 210 may use the one or more user identification attributes to identify a corresponding user profile associated with the user analytics system 102, which includes one or more associated user account parameters of the user.

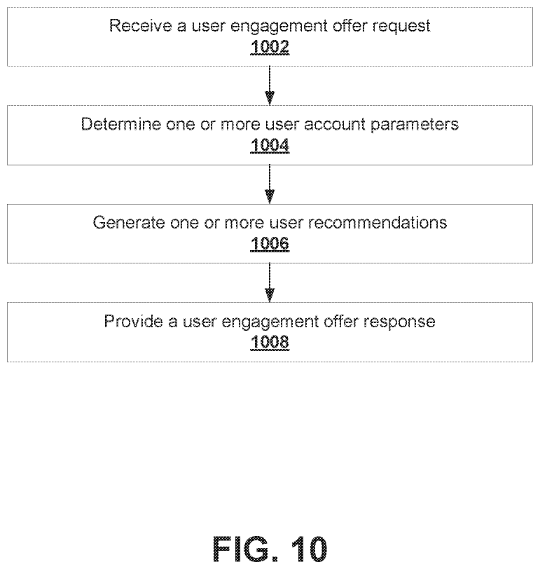

Optionally, as shown by operation 804, the apparatus 200 includes means, such as processor 202, memory 204, communications hardware 206, notification generation circuitry 210, or the like for generating one or more user engagement offer requests. Alternatively, in an instance in which it may be beneficial for a third-party entity to determine and provide one or more user recommendations for the user, the notification generation circuitry 210 may generate one or more user engagement offer requests for a third-party device (e.g., any one of third-party devices 110A-110N). The user engagement offer request may include the user identification attribute set and in some embodiments, a facility user interaction prediction and/or one or more object attributes of objects determined to be within the interaction proximity threshold such that a corresponding third-party entity may determine one or more user account parameters and generate one or more user recommendations for the user. The notification generation circuitry 210 may then use communications hardware 206 to provide one or more user engagement offer requests to one or more third-party devices (e.g., any one of third-party devices 110A-110N). The operations of generating the one or more user recommendations for the user by the third-party device are further described with respect to FIG. 10.

The notification generation circuitry 210 may identify which third-party devices to provide the user engagement offer request using one or more of the user identification attributes. For example, a user identification attribute may include a card number associated with a particular financial institution such that the notification generation circuitry 210 may identify a third-party device which is associated with said financial institution. In some embodiments, the notification generation circuitry 210 may access a third-party entity repository which stores and/or manages a plurality of third-party facilities and the associated third-party devices associated with a respective third-party entity. As such, the notification generation circuitry 210 may determine the third-party device to provide the user engagement response to using the third-party entity repository.

Optionally, as shown by operation 806, the apparatus 200 includes means, such as processor 202, memory 204, communications hardware 206, notification generation circuitry 210, or the like for receiving one or more user engagement offer responses. Once the communications hardware 206 provides the user engagement offer request, the communications hardware 206 may receive a user engagement offer response from one or more third-party devices. A user engagement offer response may include one or more user recommendations determined by a third-party entity.

As shown by operation 808, the apparatus 200 includes means, such as processor 202, memory 204, communications hardware 206, notification generation circuitry 210, or the like for determining one or more user recommendations. In particular, the notification generation circuitry 210 may determine the one or more user recommendations for a user by generating one or more user recommendations for the user based on the one or more user account parameters and/or by using the one or more user recommendations included in the one or more user engagement offer response.

In some embodiments, in an instance in which the notification generation circuitry 210 generates one or more user recommendations for the user, the notification generation circuitry 210 may determine one or more recommendations for the user based on the one or more determined user account parameters. For example, in an instance a user account parameter indicates the user has a user facility account with the facility and the user account offers a discount on purchases with the facility, the notification generation circuitry 210 may generate a user recommendation that indicates the user should use the facility account to receive the offered discount.

In some embodiments, in an instance in which the notification generation circuitry 210 generates one or more user recommendations for the user, the notification generation circuitry 210 may determine one or more currently active candidate offers associated with apparatus 200. In some embodiments, each candidate offer may be associated with a set of criteria which must be satisfied in order for a user to be eligible for the candidate offer. For example, the set of criteria may require that a user must have been associated with a facility associated with the entity for a particular time period (e.g., at least one year), meet certain financial requirements (e.g., gross income, debt-to-income, etc.), have purchased a certain amount from the facility (e.g., $500 or more within the last 5 years), and/or the like. In an instance the user account parameters are determined to satisfy the set of criteria for the candidate offer, the notification generation circuitry 210 may determine the user is eligible for the candidate offer. A candidate offer may also be associated with an offer parameter set which describe the one or more offer parameters associated with the candidate offer. For example, an offer parameter may describe a discount, financial offer (e.g., loan, credit offer, and/or the like), temporal requirements (e.g., loan repayment amount), interest rates, reward points, or other parameters associated with the offer. The notification generation circuitry 210 may then generate a user recommendation to include the one or more offers the user is determined to be eligible for and an indication of the offer parameters.

In some embodiments, a candidate offer may be associated with a particular object. As such, the notification generation circuitry 210 may use the user interaction facility prediction and/or one or more objects determined to be within an interaction proximity threshold of the current user location to determine which candidate offers to evaluate for a user. For example, a particular television may be associated with a candidate offer that allows for a 10% discount off the purchase price (as described by the offer parameter set) for users who are members of the facility loyalty program. As such, in an instance the user interaction facility prediction indicates and/or one or more objects indicate a predicted purchase of the particular television, the notification generation circuitry 210 may be configured to evaluate whether the user account parameters associated with the user satisfy the set of criteria for the particular candidate offer associated with the television.

In some embodiments, the context-aware user notification may further provide one or more instructions to the user to accept or otherwise review the offers for which the user is determined to be eligible. For example, the one or more instructions may direct the user to proceed by logging into an associated application via his/her user device, proceeding to a facility device which is configured for additional user interaction to proceed with the one or more offers, perform one or more gestures to continue to interact with the selected facility device, and/or the like.

As shown by operation 810, the apparatus 200 includes means, such as processor 202, memory 204, communications hardware 206, notification generation circuitry 210, or the like for generating a context-aware user notification based on the one or more user recommendations. Once the notification generation circuitry 210 has determined the one or more user recommendations, the notification generation circuitry 210 may generate the context-aware user notification to include the one or more user recommendations. As such, the context-aware user notification may provide the user with an indication of one or more recommendations determined for the user such as a recommended account to use for his/her purchase, one or more offers available to the user, one or more object-specific offers available to the user, and/or the like.

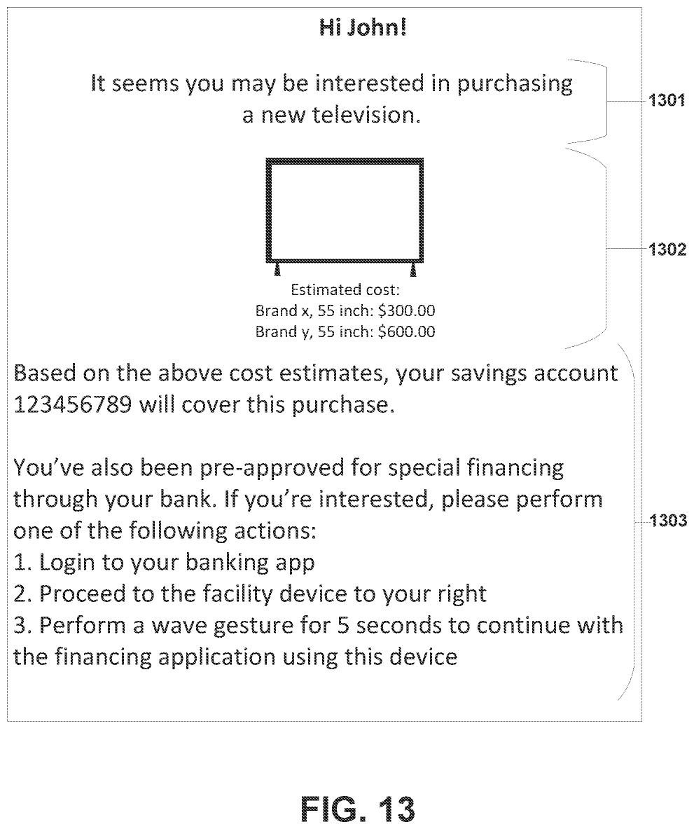

FIG. 13 illustrates an example context-aware user notification that may be displayed via a facility device. As shown in FIG. 13, the context-aware user notification may include a facility interaction prediction 1301, one or more object parameters of an object determined to be within an interaction proximity threshold 1302, and one or more user recommendations 1303.

Returning now to FIG. 4, as shown by operation 414, the apparatus 200 includes means, such as processor 202, memory 204, communications hardware 206, notification generation circuitry 210, device management circuitry 212, or the like, for providing a display message to the selected facility device. Once the display configuration set and context-aware user notification have been generated, the device management circuitry 212 may generate a display message that includes the context-aware user notification and the display configuration set. As such, the recipient selected facility device may be provided with instructions to display content of the context-aware user notification in accordance with the display configuration settings described by the display configuration set. The user may then be securely provided the context-aware user notification by the facility device.

Optionally, as shown by operation 416, the apparatus 200 includes means, such as processor 202, memory 204, communications hardware 206, or the like, for receiving a user participation request. As described above, the context-aware user notification may provide instructions to the user to accept or otherwise review the offers for which the user is determined to be eligible. In an instance in which a user engages in the one or more instructions, an associated device may provide a user participation request indicative that the user wishes to proceed with one or more of the one or more offers included in the context-aware user notification. In some embodiments, the user participation request is received from a user device (e.g., any one of user devices 106A-106N) associated with the user. In an instance in which multiple offers are presented in the context-aware user notification, the user participation request may further include one or more offers of the multiple offers which are selected by the user. In some embodiments, the user participation request is received from a facility device different that the selected facility device (e.g., any one of facility device 108A-108N). In some embodiments, the user participation request is received from the selected facility device (e.g., any one of facility device 108A-108N).

Optionally, as shown by operation 418, the apparatus 200 includes means, such as processor 202, memory 204, communications hardware 206, notification generation circuitry 210, or the like, for generating a user enrollment notification. Once the user has indicated he/she is interested in proceeding with one or more of the offers, the notification generation circuitry 210 may generate a user enrollment notification which provides additional instruction for proceeding with the particular selected offers. In some embodiments, the user enrollment notification may include a link or hyperlink to one or more websites and/or applications which may facilitate enrollment of the user in the one or more associated programs indicated by the offer.

Optionally, as shown by operation 420, the apparatus 200 includes means, such as processor 202, memory 204, communications hardware 206, or the like, for providing the user enrollment notification. In some embodiments, the communications hardware 206 may provide the user enrollment notification to the same device from which the user participation request was received such that the user may continue to use the same device to proceed with the remaining registration process. In some embodiments, the communications hardware 206 may provide the user enrollment notification to a designated facility device and may provide the user with a user enrollment notification which directs him/her to the designated facility device. As such, the user may follow the prompts and instructions on the recipient device to complete enrollment into one or more associated programs indicated by the offer such that he/she may benefit from the offer while at the facility.

### Example Operations of a Facility Device

Meanwhile, the various operations described in connection with FIG. 9 may be performed by apparatus 300, which may utilize one or more of processor 302, memory 304, communications hardware 306, notification generation circuitry 310, monitoring circuitry 314, and/or any combination thereof. In some embodiments, the operations described in connection with FIG. 9 may be performed by a facility device (e.g., any one of facility devices 108A-108N) and the facility device (described previously with reference to FIG. 1) may be embodied by one or more computing devices or servers, shown as apparatus 300 in FIG. 3.

Turning now to FIG. 9, example operations are shown for generating a user participation request for a user within a facility. For example, a facility device (e.g., any one of facility devices 108A-108N) may generate the user participation request for the user and may subsequently provide the user participation request to user analytics system 102, which may cause the operations described above in FIGS. 4-8.

As shown by operation 902, the apparatus 300 includes means, such as processor 302, memory 304, communications hardware 306, or the like, for monitoring for a user interaction request. In some embodiments, the apparatus may be positioned near an entrance of a facility such that users may interact with apparatus 300 upon entering the facility. The apparatus 300 may be configured to monitor for a user interaction request from one or more candidate users, which may indicate the corresponding user wishes to participate in the user notification program. In particular, the apparatus 300 may be configured with one or more devices such as a camera, sensors (e.g., Bluetooth sensors, near-field communication (NFC) sensors, radio frequency identification (RFID) sensors, motion sensors, and/or the like), microphones, touchscreens, displays, keypads, mouse, and/or the like. The one or more devices may be configured to monitor for a one or more user actions and in an instance a user is determined to perform one or more user actions which correspond to a user action associated with a user interaction type, the apparatus may determine a user interaction request has been detected. A user action associated with a user interaction type may describe an action that may indicate the user would like to interact with apparatus 300 to enroll in the user notification program. For example, a user interaction type may include a user standing in a particular spot for a particular period of time or longer, touching a device (e.g., touchscreen, mouse, keypad, etc.), positioning a user device, card, badge, and/or the like nearby a sensor such that the sensor may detect the user device, card, badge, etc.

As shown by operation 904, the apparatus 300 includes means, such as processor 302, memory 304, communications hardware 306, or the like, for determining whether a user interaction request was detected. In an instance in which a user interaction request is not detected, the process may proceed to operation 902 where apparatus 300 may continue to monitor for a user interaction request.

In an instance in which a user interaction request is detected, the process may proceed to operation 906. As shown by operation 906, the apparatus 300 includes means, such as processor 302, memory 304, communications hardware 306, monitoring circuitry 314 or the like, for capturing one or more user images. In particular, the monitoring circuitry 314 may cause one or more associated devices, such as one or more cameras associated with the apparatus 300 to capture one or more images of the user. In some embodiments, the monitoring circuitry 314 may capture the one or more user images at different angles and/or at different zoom values. As such, a more complete image of the user may be generated from the one or more user images to allow the user characteristic attribute set to be more accurately generated.

As shown by operation 908, the apparatus 300 includes means, such as processor 302, memory 304, communications hardware 306, monitoring circuitry 314 or the like, for generating a user characteristic attribute set. In some embodiments, the monitoring circuitry 314 may process the one or more user images to generate one or more user characteristic attributes and a user characteristic attribute set which may include the one or more user characteristic attributes. In some embodiments, the monitoring circuitry 314 may use one or more attribute detection models to process the one or more user images.

An attribute detection model may use any suitable image processing techniques to process the one or more user images. In some embodiments, the attribute detection model may be a machine learning model (e.g., a convolutional neural network and/or deep learning model) trained to process the one or more user images and generate one or more user characteristic attributes. In particular, the attribute detection model may use computer vision techniques that may identify characteristics of the user from the one or more user images and may further ascribe values or attributes to each characteristic. In particular, the attribute detection model may be trained to recognize and identify certain characteristic of the user and values of the characteristic. For example, the attribute detection model may be trained to recognize a shirt (e.g., a characteristic) of the user and may further determine one or more attributes of the shirt (e.g., length, color, style, etc.). In some embodiments, a user characteristic attribute may describe a detected characteristic and corresponding attribute. In some embodiments, a user characteristic attribute may include a portion of the user image which depicts a characteristic (e.g., the image of the shirt of the user).

In some embodiments, the monitoring circuitry 314 may include the one or more user images in addition to or in lieu of the user characteristic attribute set such that the user analytics system 102 may process the one or more user images.

As shown by operation 910, the apparatus 300 includes means, such as processor 302, memory 304, communications hardware 306, monitoring circuitry 314 or the like, for generating a user identification request. In some embodiments, the monitoring circuitry 314 may generate a user identification request in an instance in which a user has not yet performed a user interaction from which one or more user identification attributes may be determined. In particular, the user identification request may request that the user scan or insert an associated card (e.g., payment card, customer card, etc.) using one or more sensors, scan an associated user device, or enable sharing via an associated user device.

As shown by operation 912, the apparatus 300 includes means, such as processor 302, memory 304, communications hardware 306, or the like, for providing the user identification request. In some embodiments, the communications hardware 306 may provide the user identification request to a monitor or display associated with apparatus 300 such that the user identification request may be displayed to the user. Additionally or alternatively, the communications hardware 306 may provide the user identification request to an associated user device (e.g., any one of user devices 106A-106N), such as via Bluetooth or NFC.

As shown by operation 914, the apparatus 300 includes means, such as processor 302, memory 304, communications hardware 306, monitoring circuitry 314 or the like, for generating a user identification attribute set based on a user identification response. The communications hardware 306 may receive a user identification response, which may be provided in response to the user identification request. The user identification response may be received from a device associated with apparatus 300 (e.g., a sensor, keyboard, mouse, etc.), one or more facility devices which do not correspond to apparatus 300, and/or a user device.

The user identification response may include one or more user identification attributes such as a username, phone number, email address, account number, card number (e.g., credit card, debit card, loyalty card, etc.), driver's license, user device identification number (e.g., IMEI, serial number, etc.), user device information (e.g., make, model, version, device name, etc.), and/or the like. The monitoring circuitry 314 may then generate the user identification attribute set to include each of the one or more user identification attributes included in the user identification response.

As shown by operation 916, the apparatus 300 includes means, such as processor 302, memory 304, communications hardware 306, monitoring circuitry 314 or the like, for generating the user participation request. Once the monitoring circuitry 314 has generate the user characteristic attribute set and the user identification attribute set, the monitoring circuitry 314 may generate the user participation request. The user participation request may include the user characteristic attribute set and the user identification attribute set.

As shown by operation 918, the apparatus 300 includes means, such as processor 302, memory 304, communications hardware 306, or the like, for providing the user participation request. Once the monitoring circuitry 314 has generated the user participation request, the communications hardware 306 may provide the user participation request to the user analytics system 102. Upon provision of the user participation request to the user analytics system 102, the user analytics system 102 may perform the one or more operations described above with respect to FIGS. 4-8.

### Example Operations of a Third-Party Device

Meanwhile, the various operations described in connection with FIG. 10 may be performed by apparatus 300, which may utilize one or more of processor 302, memory 304, communications hardware 306, notification generation circuitry 310, monitoring circuitry 314, and/or any combination thereof. In some embodiments, the operations described in connection with FIG. 10 may be performed by a third-party device (e.g., any one of third-party devices 110A-110N) and the third-party device (described previously with reference to FIG. 1) may be embodied by one or more computing devices or servers, shown as apparatus 300 in FIG. 3.

Turning now to FIG. 10, example operations are shown for generating one or more user recommendations for users within a facility by a third-party. For example, the user analytics system 102 may be associated with a merchant, retailer, business, vendor, or the like and the third-party entity may be associated with a financial institution. The third-party entity may use a third party device (e.g., one or more of third-party devices 110A-110N) to generate one or more user recommendations for a user while the user is within the facility. The third-party entity may determine the one or more user recommendations based on a received user engagement offer request, which may include the user identification attribute set and, in some embodiments, the user facility interaction prediction. As such, the third-party entity may determine one or more user account parameters for the user and then generate one or more user recommendations for the user. Thus, the context-aware notification securely presented to the user may include user recommendations from a third-party entity while the user is still within the facility without requiring the user to directly interact with the third-party entity.

As shown by operation 1002, the apparatus 300 includes means, such as processor 302, memory 304, communications hardware 306, or the like, for receiving a user engagement offer request. As described above, the user engagement offer request may include the user identification attribute set and, in some embodiments, a facility user interaction prediction and/or one or more object attributes of objects determined to be within the interaction proximity threshold. The user engagement offer request may be received from the user analytics system 102.

As shown by operation 1004, the apparatus 300 includes means, such as processor 302, memory 304, communications hardware 306, notification generation circuitry 310 or the like, for determining one or more user account parameters. The notification generation circuitry 310 may determine the one or more user account parameters based on the user identification attribute set. As described above, the user identification attributes may include a username, phone number, email address, account number, card number (e.g., credit card, debit card, loyalty card, etc.), driver's license, user device identification number (e.g., IMEI, serial number, etc.), user device information (e.g., make, model, version, device name, etc.), and/or the like. Associated user account parameters may then be determined for the user using the one or more user identification attributes. For example, the notification generation circuitry 310 may use the one or more user identification attributes to identify a corresponding user profile associated with the third-party entity associated with apparatus 300, which includes one or more associated user account parameters of the user.

As shown by operation 1006, the apparatus 300 includes means, such as processor 302, memory 304, communications hardware 306, notification generation circuitry 310 or the like, for generating one or more user recommendations. In some embodiments, in an instance in which the notification generation circuitry 310 generates one or more user recommendations for the user, the notification generation circuitry 310 may determine one or more recommendations for the user based on the one or more determined user account parameters. For example, in an instance a user account parameter indicates the user has one or more user accounts with the third-party entity and the user account offers rewards on certain types of purchases which corresponds to the one or more objects included in the user engagement offer request, the notification generation circuitry 310 may generate a user recommendation that indicates the user should use the corresponding user account to facilitate the purchase. Additionally or alternatively, the notification generation circuitry 310 may advise or otherwise indicate whether a user account has enough funds to cover a predicted purchase, which may be determined based on the one or more object attributes associated with objects included in the user engagement offer request.

In some embodiments, in an instance in which the notification generation circuitry 310 generates one or more user recommendations for the user, the notification generation circuitry 310 may determine one or more currently active candidate offers associated with apparatus 300. In some embodiments, each candidate offer may be associated with a set of criteria which must be satisfied in order for a user to be eligible for the candidate offer. In an instance the user account parameters are determined to satisfy the set of criteria for the candidate offer, the notification generation circuitry 310 may determine the user is eligible for the candidate offer. A candidate offer may also be associated with an offer parameter set which describe the one or more offer parameters associated with the candidate offer. For example, an offer parameter may describe a discount, financial offer (e.g., loan, credit offer, and/or the like), temporal requirements (e.g., loan repayment amount), interest rates, reward points, or other parameters associated with the offer. The notification generation circuitry 310 may then generate a user recommendation to include the one or more offers the user is determined to be eligible for and an indication of the offer parameters.

In some embodiments, the context-aware user notification may further provide one or more instructions to the user to accept or otherwise review the offers for which the user is determined to be eligible. For example, the one or more instructions may direct the user to proceed by logging into an associated application via his/her user device or to contact a third-party entity representative.

As shown by operation 1008, the apparatus 300 includes means, such as processor 302, memory 304, communications hardware 306, or the like, for providing the user engagement offer response. Once the notification generation circuitry 308 has generated the one or more user recommendations, the communications hardware 306 may provide a user engagement offer response to the user analytics system 102. The user engagement offer response may include the one or more user recommendations determined by apparatus 300 such that the user analytics system may generate a context-aware user notification which includes these user recommendations.

FIGS. 4-10 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example System Interaction

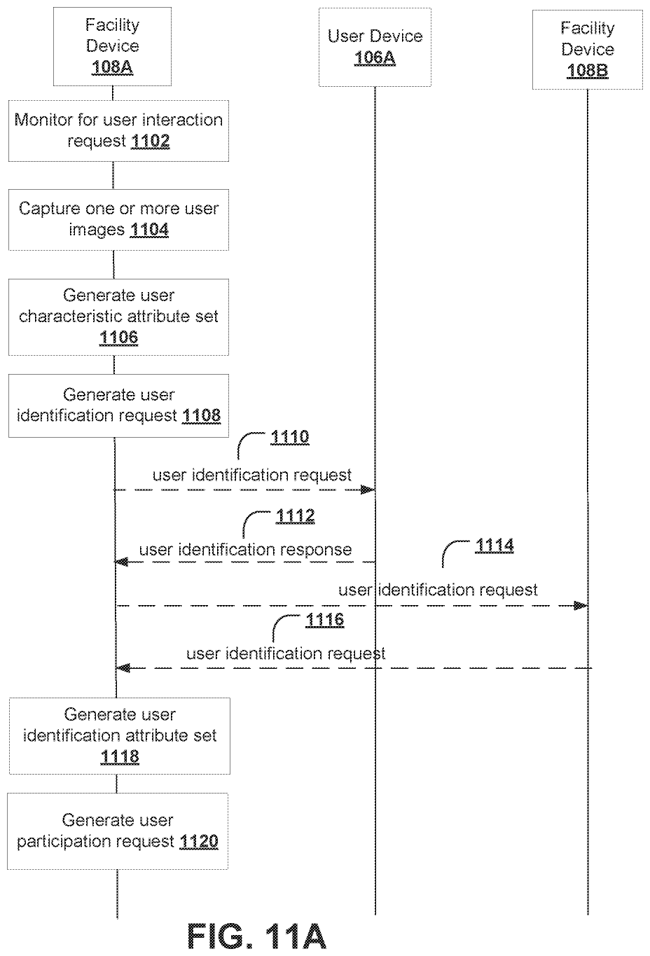

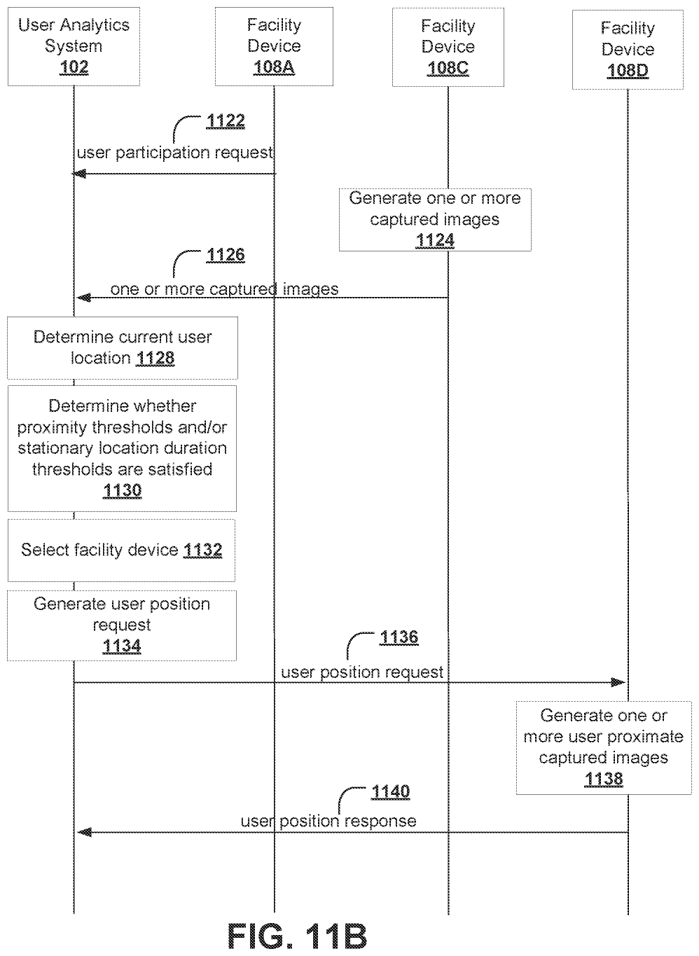

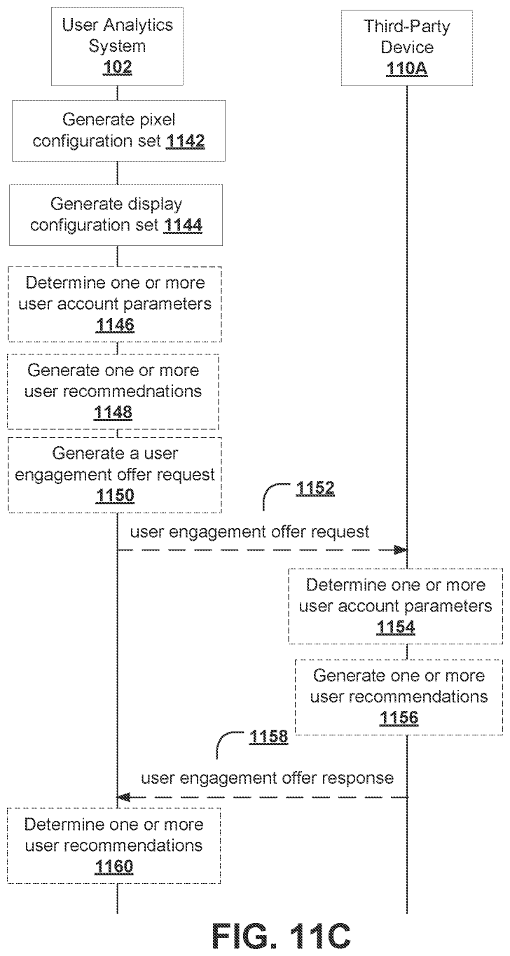

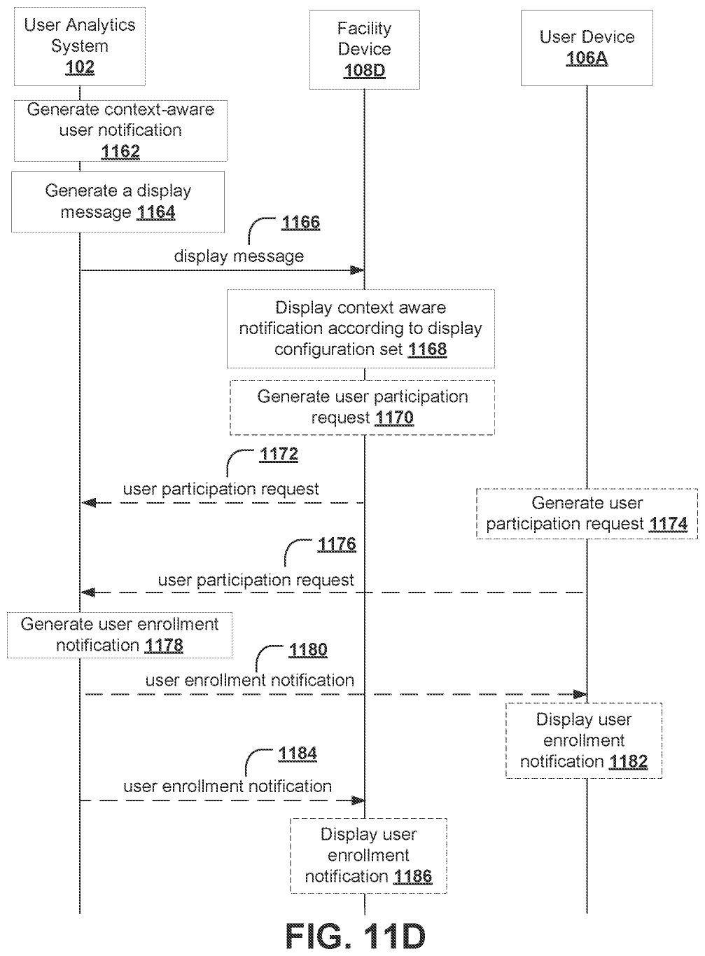

FIGS. 11A-11D show a swim lane diagram illustrating example operations (e.g., as described above in connection with FIGS. 4-10) performed by components of the environment depicted in FIG. 1 to produce various benefits of the implementations described herein. The operations shown in the swim lane diagram performed by user analytics system 102 are shown along the line extending from the box labeled “user analytics system 102,” operations performed by a facility device (e.g., any one of facility devices 108A-108N) are shown along the line extending from the box labeled “facility device 108A,” operations performed by facility device (e.g., any one of facility devices 108A-108N) are shown along the line extending from the box labeled “facility device 108B.” operations performed by facility device (e.g., any one of facility devices 108A-108N) are shown along the line extending from the box labeled “facility device 108C.” operations performed by a facility device (e.g., any one of facility devices 108A-108N) are shown along the line extending from the box labeled “facility device 108D,” operations performed by a third-party device (e.g., any one of third-party devices 110A-110N) are shown along the line extending from the box labeled “third-party device 110A.” and operations performed by a user device (e.g., any one of user devices 106A-106N) are shown along the line extending from the box labeled “user device 106A.” Operations impacting multiple devices, such as data transmissions between the devices, are shown using arrows extending between these lines. Generally, these operations are ordered temporally with respect to one another. However, it will be appreciated that the operations may be performed in other orders from those illustrated in FIGS. 11A-11D. Additionally, it will be appreciated that the facility device 108A, facility device 108B, facility device 108C, and/or facility device 108D may be separate devices or may be the same device.

As shown in FIG. 11A, at operation 1102, the facility device 108A monitors for a user interaction request. At operation 1104, the facility device 108A captures one or more user images in response to detection of a user interaction request. At operation 1106, the facility device 108A generates a user characteristic attribute set. At operation 1108, the facility device 108A generates a user identification request. At operation 1110, the facility device 108A may provide the user identification request to the user device 106A and at operation 1112, the user device 106A may provide a user identification response. Additionally or alternatively, at operation 1114 the facility device 108A may provide the user identification request to facility device 108B and at operation 1116, the facility device 108B may provide a user identification response. At operation 1118, the facility device 108A generates a user identification attribute set. At operation 1120, the facility device 108A generates a user participation request, which includes the user characteristic attribute set and the user identification attribute set.

Turning now to FIG. 11B, at operation 1122, the facility device 108A provides the user participation request to the user analytics system. At operation 1124, facility device 108C generates one or more captured images. At operation 1126, the facility device 108C provides the one or more captured images to the user analytics system 102. At operation 1128, the user analytics system 102 determines the current ser location. At operation 1130, the user analytics system 102 determines whether one or more proximity thresholds and/or one or more stationary location duration thresholds are satisfied. At operation 1132, in an instance in which the user analytics system 102 determines the one or more proximity thresholds and/or one or more stationary location duration thresholds are satisfied, the user analytics system 102 selects a facility device (e.g., facility device 108D). At operation 1134, the user analytics system 102 generates a user position request. At operation 1136, the user analytics system 102 provides the user position request to the facility device 108D. At operation 1138, the facility device 108D generates one or more user proximate captured images. At operation 1140, the facility device 108D provides a user position response which includes the one or more user proximate captured images to the user analytics system 102.

Turning now to FIG. 11C, at operation 1142, the user analytics system 102 generates a pixel configuration set. At operation 1144, the user analytics system 102 generates a display configuration set. Optionally, at operation 1146, the user analytics system 102 determines one or more user account parameters. Optionally, at operation 1148, the user analytics system 102 generates one or more user recommendations based on the one or more user account parameters determined at operation 1146. Additionally or alternatively, at operation 1150, the user analytics system 102 generates a user engagement offer request. Optionally, at operation 1152, the user analytics system 102 provides the user engagement offer request to third-party device 110A. Optionally, at operation 1154, the third-party device 110A determines one or more user account parameters. Optionally, at operation 1156, the third-party device 110A generates one or more user recommendations. Optionally, at operation 1158, the third-party device 110A provides a user engagement offer response which includes the one or more user recommendations generated at operation 1156 to the user analytics system 102. Optionally, at operation 1160, the user analytics system 102 determines one or more user recommendations based on the received user engagement offer response.

Turning now to FIG. 11D, at operation 1162, the user analytics system 102 generates a context-aware user notification. At operation 1164, the user analytics system 102 generates a display message which includes the context-aware user notification and the display configuration set. At operation 1166, the user analytics system 102 provides the display message to the facility device 108D. At operation 1168, the facility device 108D displays the context-aware notification in accordance with the parameters described by the display configuration set. Optionally, at operation 1170, the facility device 108D generates a user participation request (e.g., in response to detection of user interaction) and at operation 1172, the facility device 108D provides the user participation request to the user analytics system 102. Additionally or alternatively, at operation 1174, the user device 106A generates a user participation request (e.g., in response to detection of user interaction) and at operation 1176, the user device 106A provides the user participation request to the user analytics system 102. At operation 1178, the user analytics system 102 generates a user enrollment notification. Optionally, at operation 1180, the user analytics system 102 provides the user enrollment notification to the user device 106A and at operation 1182, the user device 106A displays the enrollment notification. Additionally or alternatively, at operation 1184, the user analytics system 102 provides the user enrollment notification to the facility device 108D and at operation 1186, the facility device 108D displays the enrollment notification.

In some embodiments, some of the operations described above in connection with FIGS. 4-10 may be modified or further amplified. Furthermore, in some embodiments, additional optional operations may be included. Modifications, amplifications, or additions to the operations above may be performed in any order and in any combination.

### CONCLUSION

As described above, example embodiments provide methods and apparatuses that enable improved generation and presentation of context-aware and bespoke information for a user. Example embodiments thus provide tools that overcome the problems faced by conventional techniques which are limited to static displays due to privacy and/or security concerns. In contrast to these conventional static techniques for generation and presentation of facility-specific information, example embodiments described herein allow for the generation of bespoke context-aware user notification that may be securely presented to the user using a facility device. In particular, a user may choose to opt into a user notification program that allows facility devices to securely provide context-aware user notification to the user within a facility. To do so, the user may interact with a facility device, which may capture user characteristic attributes of the user and user identification attributes. A user analytics system may then track the user throughout the facility using the user identification attributes and for the duration of the user's time within the facility, the user may be presented with context-aware user notifications when they are within a particular proximity to a facility device such that the facility device may display the context-aware user notification to the user in a secure and private manner.

Additionally, techniques described herein may only utilize, store, or otherwise maintain the one or more user characteristic attributes in the user characteristic attribute set for the duration the user is within the facility. The user characteristic attributes may be deleted after the user location cannot be determined for a predetermined time. As opposed to conventional tracking systems which may use biometric data, the use of a user characteristic attribute set advantageously allows for any user to opt into the user notification program and does not require that the user be registered with a user profile associated with the facility. As such, biometric data of the user need not be stored by facility in order for the user to opt into the user notification program.

The context-aware user notification may be generated based on the current location of the user and in some embodiments, based on a user facility interaction prediction and displayed using a display associated with a facility device such that the content of the context-aware user notification may be relevant to the user's current location within the facility. The facility device may display the content of the context-aware user notification based on a display configuration set, which indicates parameters for pixels of the display such that the content is only viewable to the intended user. As such, the user may be securely presented with context-aware user notifications that contain location-relevant information for the user as they move throughout the facility.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for securely presenting a context-aware user notification to a user using a facility device, the method comprising:
receiving, by communications hardware, a user participation request for the user, wherein the user participation request comprises (i) a user characteristic attribute set and (ii) a user identification attribute set;
determining, by user tracking circuitry and based on the user characteristic attribute set and a temporal image set, a current user location;
generating, by device management circuitry and based on the current user location, a display configuration set for a facility device indicative of instructions for the facility device for displaying the context-aware user notification;
generating, by notification generation circuitry and based on the current user location and the user identification set, the context-aware user notification; and
providing, by the communications hardware, a display message to the facility device, wherein the display message comprises the context-aware user notification and the display configuration set.

2. The method of claim 1, further comprising:
determining, by the device management circuitry, whether the current user location satisfies one or more proximity thresholds for one or more facility devices; and
in an instance in which the current user location satisfies one or more proximity thresholds for at least one facility device of the one or more facility devices, selecting, by the device management circuitry, the at least one facility device to be the facility device.

3. The method of claim 1, further comprising:
generating, by the device management circuitry, a user position request; and
providing, by the communications hardware, the user position request to the facility device.

4. The method of claim 3, further comprising:
receiving, by the communications hardware, a user position response; and
generating, by the device management circuitry and based on the user position response, a pixel configuration set for the facility device, wherein (i) the pixel configuration set comprises instructions for one or more of a wavelength, power, brightness, or orientation for a pixel set associated with the facility device and (ii) the display configuration set comprises the pixel configuration set.

5. The method of claim 4, wherein the user position response comprises one or more user proximate captured images, and
wherein the method further comprises determining, by the device management circuitry and based on the one or more user proximate captured images, a user orientation position set comprising one or more of (i) a user distance relative to the facility device, (ii) a user vertical orientation relative to a vertical reference plane of the facility device, or (iii) a user horizontal orientation relative to a horizontal reference plane of the facility device, wherein determining the pixel configuration set is generated based on the user orientation position set.

6. The method of claim 1, further comprising:
receiving, by the communications hardware, a user participation request;
generating, by the notification generation circuitry and based on the user participation request, a user enrollment notification; and
providing, by the communications hardware, the user enrollment notification.

7. The method of claim 1, further comprising determining, by the notification generation circuitry and based on the current user location, a user facility interaction prediction, wherein generating the context-aware user notification is further based on the user facility interaction prediction.

8. The method of claim 7, further comprising:
querying, by the notification generation circuitry, a facility object database one or more objects which are within an interaction proximity threshold of the current user location, wherein (i) the facility object database comprises (a) one or more objects within the facility, (b) a corresponding location for each of the one or more objects within the facility, and (c) one or more attributes for each of the one or more objects and (ii) determining the user facility interaction prediction is further based on the one or more objects determined to be within the interaction proximity threshold of the current user location.

9. The method of claim 1, further comprising:
receiving, by communications hardware, one or more captured images over a time frame, wherein (i) each captured image is associated with (a) a captured image timestamp indicative of the time the image was captured and (b) a facility device identifier and (ii) each facility device identifier is associated with an image capture location radius within the facility;
determining, by the user tracking circuitry and based on the one or more captured images and the user characteristic attribute set, whether the user is included in one or more of the one or more captured images; and
in an instance in which the user is included in one or more of the one or more captured images, appending, by the user tracking circuitry, the one or more captured images to a temporal image set.

10. The method of claim 9, further comprising:
identifying, by the user tracking circuitry, a captured image from the temporal image set which is associated with a most recent image timestamp;
determining, by the user tracking circuitry, whether the most recent image timestamp satisfies one or more temporal thresholds; and
in an instance in which the most recent image timestamp satisfies the one or more temporal thresholds, determining, by the user tracking circuitry, the current user location based on the captured image associated with the most recent image timestamp.

11. The method of claim 9, further comprising:
determining, by the user tracking circuitry based on the temporal image set, a user stationary location duration; and
determining, by the user tracking circuitry, whether the user stationary location duration satisfies one or more user stationary location duration thresholds, wherein in an instance in which the user stationary location duration satisfies one or more user stationary location duration thresholds, the notification generation circuitry generates the context-aware user notification.

12. The method of claim 1, further comprising:
determining, by the notification generation circuitry and based on the user identification attribute set, one or more user account parameters for the user; and
determining, by the notification generation circuitry and based on the one or more user account parameters, one or more user recommendations, wherein the context-aware user notification comprises the one or more user recommendations.

13. The method of claim 1, further comprising:
generating, by the notification generation circuitry based on the user identification attribute set, one or more user engagement offer requests;
receiving, by communications hardware, one or more user engagement offer responses in response to a provision of the one or more user engagement offer requests, wherein (i) the one or more user engagement offer request comprise one or more user recommendations and (ii) the context-aware user notification comprises the one or more user recommendations; and
determining, by the notification generation circuitry and based on the one or more user engagement offer responses, one or more user recommendations, wherein the context-aware user notification comprises the one or more user recommendations.

14. An apparatus for securely presenting a context-aware user notification to a user using a facility device, the apparatus comprising:
communications hardware configured to receive a user participation request for the user, wherein the user participation request comprises (i) a user characteristic attribute set and (ii) a user identification attribute set;
user tracking circuitry configured to determine, based on the user characteristic attribute set and a temporal image set, a current user location;
device management circuitry configured to generate, based on the current user location, a display configuration set for a facility device indicative of instructions for the facility device for displaying the context-aware user notification; and
notification generation circuitry configured to generate, based on the current user location and the user identification set, the context-aware user notification,
wherein the communications hardware is further configured to provide a display message to the facility device, wherein the display message comprises the context-aware user notification and the display configuration set.

15. The apparatus of claim 14, wherein the device management circuitry is further configured to:
determine whether the current user location satisfies one or more proximity thresholds for one or more facility devices; and
in an instance in which the current user location satisfies one or more proximity thresholds for at least one facility device of the one or more facility devices, select the at least one facility device to be the facility device.

16. The apparatus of claim 14, wherein the device management circuitry is further configured to generate a user position request, and
the communications hardware is further configured to provide the user position request to the facility device.

17. The apparatus of claim 16, wherein the communications hardware is further configured to receive a user position response; and
the device management circuitry is further configured to generate, based on the user position response, a pixel configuration set for the facility device, wherein (i) the pixel configuration set comprises instructions for one or more of a wavelength, power, brightness, or orientation for a pixel set associated with the facility device and (ii) the display configuration set comprises the pixel configuration set.

18. The apparatus of claim 17, wherein the user position response comprises one or more user proximate captured images, and
the device management circuitry is further configured to determine, based on the one or more user proximate captured images, a user orientation position set comprising one or more of (i) a user distance relative to the facility device, (ii) a user vertical orientation relative to a vertical reference plane of the facility device, or (iii) a user horizontal orientation relative to a horizontal reference plane of the facility device, wherein determining the pixel configuration set is generated based on the user orientation position set.

19. The apparatus of claim 14, wherein the communications hardware is further configured to receive a user participation request,
the notification generation circuitry is further configured to generate, based on the user participation request, a user enrollment notification, and
the communications hardware is further configured to provide the user enrollment notification.

20. A computer program product for securely presenting a context-aware user notification to a user using a facility device, the computer program product comprising at least one non-transitory computer-readable storage medium storing software instructions that, when executed, cause an apparatus to:
receive a user participation request for the user, wherein the user participation request comprises (i) a user characteristic attribute set and (ii) a user identification attribute set;
determine, based on the user characteristic attribute set and a temporal image set, a current user location;
generate, based on the current user location, a display configuration set for a facility device indicative of instructions for the facility device for displaying the context-aware user notification;
generate, based on the current user location and the user identification set, the context-aware user notification; and
provide a display message to the facility device, wherein the display message comprises the context-aware user notification and the display configuration set.
